(19) United States
(12) Patent Application Publication
(10) Pub. No.: US 2014/0358777 A1
(43) Pub. Date: Dec. 4, 2014

(54) METHOD FOR SECURE ATM TRANSACTIONS USING A PORTABLE DEVICE

(71) Applicant: How Kiap Gueh, Singapore (SG)

(72) Inventor: How Kiap Gueh, Singapore (SG)

(21) Appl. No.: 14/293,096

(22) Filed: Jun. 2, 2014

(30) Foreign Application Priority Data
May 31, 2013 (SG) 201304250-2

(51) Int. Cl. G06Q 20/32; G06Q 20/40; G06Q 20/10

(52) U.S. Cl. CPC G06Q 20/3223; G06Q 20/1085; G06Q 20/40
USPC 705/43

(57) ABSTRACT

The application provides a transaction-processing system for performing multi-factor verification of transactions between a plurality of users and a verification processor. The processor is in operational communication with a database storing a plurality of verification records, wherein each record comprises a unique ID and said record containing at least one MSISDN value. Each record comprises at least one reference device serial number value, and each verification record logically and uniquely associated with each of the said plurality of users. The system comprises a routine for reading from a first memory space a verification request message and routine associating said request message to an associated verification record stored on database.

### CROSS-REFERENCE TO RELATED APPLICATIONS

This application claims priority to Singapore application SG201304250-2, filed May 31, 2013, which is incorporated by reference herein in its entirety.

### TECHNICAL FIELD

The present application relates to remote customer-bank communication such as automated teller machine (ATM) transactions, electronic banking access with a computer device over a data network such as the Internet, a POS (point-of-sale) terminal host network, a credit card host network, a debit card host network, a currency remittance application host network, or a combination thereof.

### FIELD OF THE PRESENT INVENTION

Over 1 million ATM machines are operational worldwide and this electronic equivalent of a bank's branch has allowed card issuers to multiply their service footprint more than any physical branch network can cover, especially with the introduction, development and vertical service integration of payment processing systems. In these systems, essentially EFT networks that provides telecommunications and payment infrastructure to link consumers, merchants, banks, ATMs, network switch operators, authorization data messages are routed, interpreted, encrypted, decrypted, to the appropriate parties and computer host systems millions of times each day.

In addition to EFT transactions, these payment processing systems also process POS transactions, and these systems (EFT networks) can be regional, national, or cross border. An example would be the ATM networks operated by Visa (“Visa Plus”), and MasterCard (“Cirrus”), while the same parties also operate their respective POS systems (Visa “Interlink” and MasterCard “Maestro”). For instance, in the United States, in addition to the above two national networks, regional ATM network operators include (partial list) the following;

| Name of operator | Average number of ATMs |
|---|---|
| Star | 250,000 |
| NYCE | 80,000 |
| Accel/Exchange | 28,000 |
| MoneyMaker | 25,000 |
| Credit Union 24 | 7,500 |
| Pulse | 95,000 |

Although ATMs do in general not represent bank branches, the fee and pricing regime that has since defined in a significant manner how secure authentication infrastructure is deployed from issuer to consumer. For both retail and wholesale inter-systems, there are periodic and per transaction fees the consumer ultimately incurs. Depending on whether the consumer using a particular ATM is a direct customer of the bank that owns the ATM or not, there is a prospect of the transaction being routed through multiple processing entities/parties from the ATM operator, to its network owner, to a network switch processor, and its corresponding payment processing system, and finally to the issuer/bank.

This has significant technical ramifications in the conception, design and implementation of party authentication related infrastructure, in some such systems, the card issuer (or bank) may have a database of its cardholders with a selected payment processor for transaction verification.

In one example, the transaction is between the consumer (also called the cardholder) and the issuer (also called the bank). The consumer uses the ATM that is owned by the issuer in which case implementation of any security mechanism is straightforward since routing of authorization request and authorization response data is within the issuer's own network.

In a further example, the consumer may use the ATM of another different issuer in this case the processing of the transaction would involve at least one network switch party, under the assumption that the consumer's issuer is using the same payment processor as the “foreign” ATM.

The above basic examples have numerous variations which are increasingly complicated since the ATM may be owned by a third party, the processor network of such an ATM does not have a fee agreement with the switch operator within the region etc.

### BRIEF DESCRIPTION OF THE FIGURES

FIG. 1 shows a general embodiment of the application featuring a default PIN, private PIN arrangement for multi-factor ATM verification.

FIG. 2 shows a general embodiment of the application featuring the multi-factor verification system where the cardholder/user is required to input a transaction confirmation option.

FIG. 3 shows the overall schematic and system architecture of the transaction-processing engine performing two example transactions.

FIG. 4 shows one embodiment of the application where verification of either the cardholder or the cardholder's phone device is implemented during transaction request processing.

FIG. 5 shows one embodiment similar to FIG. 4 where multiple counter-parties and their respective network domains are disclosed.

FIG. 6 shows one embodiment similar to FIG. 5 where multiple counter-parties and their respective network domains are disclosed.

FIG. 7 shows how the gateway establishes a messaging service session with a mobile station (also termed portable device, or phone device, or communications device).

FIG. 8 shows one embodiment where a plurality of cardholder confirmation options are displayed during the messaging service session of FIG. 7 on the cardholder's elected phone device bearing the MSISDN of FIG. 7.

FIG. 9 and FIG. 10 shows another embodiment similar to that of FIG. 8 with the additional action of polling from the phone device its device serial number.

FIG. 11 shows another embodiment similar to that of FIG. 6, where an EMV card apparatus labeled ATM-CD is utilized by the cardholder.

FIG. 12 shows the scenario in FIG. 11 where the cardholder elects to send a “send alarm” confirmation option during the messaging service session between a gateway and the cardholder's phone device.

FIG. 13 shows the method where the EMV card is invalidated after the action taken by cardholder of FIG. 12.

FIG. 14, 15 and FIG. 16 show a block code routine loaded on the cardholder's phone device to implement encryption of a communications link between the phone device and verification processor and the transmittal of an encrypted PIN code from the phone device to the processor.

FIG. 17 shows a cardholder or mobile user input request message that is transmitted by the issuer/verification system to the mobile device of the mobile user.

FIG. 18-FIG. 19 shows an example of the present application in the field of electronic banking and general computer network logon access control.

FIG. 20 shows a schematic of the present application comprising a primary and secondary database.

### DETAILED DESCRIPTION OF EMBODIMENTS OF THE APPLICATION

The present application relates to a remote customer-bank communication such as a multi-factor verification system for automated teller machine (ATM) transactions wherein the ATM routes a transaction request message to a verification processor which in turn retrieves the MSISDN or IMSI value of a related cardholder associated with the said request message and establishes a communications link with a cardholder communication device, e.g. a phone device, thereby presenting a plurality of cardholder response options to which the cardholder shall elect one such option back to the verification processor. The verification process will generate a transaction authorization message and route the authorization message to the ATM for subsequent execution. Plurality of response options comprises a transaction confirmation, a transaction cancellation and an alert request to which the verification processor will generate a suitable authorization message to terminate the transaction and invalidate the card apparatus used.

This application allows a cardholder of an issuer (such as a bank, financial institution, credit provider etc) to make transactions with either a ATM (automated teller machine), a merchant (both in point-of-sale environments and internet-based purchases) or the issuer itself (such as a electronic banking web-site) where each transaction will trigger a user input request message such as a USSD service message on the cardholder's phone.

The remote customer-bank communication can be triggered by inserting a card into a card-reader or by accessing a specific Internet homepage, which will save time, so that the communication link is already established when the transaction data is entered by a user.

The message may be simple, such as a short confirmation, that a transaction is going to take place, but it is not limited to that. The message may indicate more details, such as the transaction amount, and provide a menu for the cardholder to respond.

For example, the cardholder may be presented with a message menu that shows the transaction amount, and then some menu options for the cardholder to confirm or cancel the transaction, and the cardholder sends back a response message with an elected menu option choice.

The cardholder can also send an alarm request to the issuer when the cardholder is not making the transaction and wants the related card to be invalidated.

Another aspect of this application is an ATM transaction system where a cardholder is given two PIN codes, one being a “default” PIN code and the other being the “real” or “private” PIN code. The cardholder uses the ATM card with any ATM device using the “default” PIN code, and gets a message on the cardholder's phone with a prompt to enter the “real” or “private” PIN code.

The “default” PIN code is easy to remember and is actually issued to a group of cardholders, such as “11111”, or “77777”.

This aspect of the application foils tampered ATMs where pinhole cameras and card readers may be present to steal the cardholder's card details and record the “real” PIN code. It also foils “fake” ATM devices built specifically to do the same. This aspect of the application makes global deployment and interoperability a non-issue, since there is no software or hardware modifications whatsoever required of the ATM device itself.

The “engine” of the system, being the transaction-processing aspect of this application, is also disclosed wherein parts of the system are configured to be fully compliant with ISO 8583 financial transaction card originated messages.

There is also a load balancing mechanism disclosed for managing loads for a gateway host computer responsible for making the above phone-based messaging service with each cardholder.

Finally, a cryptographic routine code example is also disclosed in this application in order to encrypt such messaging services especially during any prompt from the cardholder for the input of the PIN code in order to comply with various industry standards such as PCI Data Security Standards (DSS), PCI PIN Transaction Security (PTS).

At the payment processor level, with the involvement of settlement banks and clearing banks between different processors having a reciprocal fee sharing agreement, while operationally may not require any exchange of data in relation to each transaction, does have an impact on how pricing and fees are determined.

As a result, mass deployment of a single unified security mechanism is difficult, fee allocation and pricing becomes sensitive and operational liability and transaction flag boundaries taking time to evaluate. In another example, where there are two issuers A and B, a consumer holding a card from issuer B may need to use an ATM owned by issuer A, and the issuer A is not in the same region or country as issuer B, hence the list of fees chargeable may look like this where:

### a) Foreign (Overseas) Charge

b) Surcharge payable from consumer to issuer A for use of ATM
c) Interchange fee between issuer A and B
d) Switch fee incurred by issuer B to network switch processor

A user may be interchangeably called a consumer, a cardholder, and is understood to be the person having prepaid credit, credit, funds with a financial service provider such as a credit union, a bank, such a provider thus called issuer.

The payment processor is the entity that has some form of operational connection between itself and the issuer, and in some cases, with other third parties such as a credit association, another issuer, or yet another payment processor entity.

In transactions not related to ATM transactions, such as those relating to a credit/debit card system, where there is the issuer, cardholder, merchant, card acquirer/network interchange operator, payment processor will also refer to the collective group of merchants, card acquirer/network interchange operator. The term card acquirer is the bank or party that maintains the operating relationship with the merchant and the card association (such as Visa, MasterCard, Amex, JCB etc.), and in some cases, the network interchange operator is the card association or one of its members.

For purposes of this application all such entities (ATM network operator, card association, merchant, card acquirer, interchange network operator) are thereby called the payment processor, so long as they perform the role of transmittal, routing, processing, forwarding of electronically formatted messages in relation to an underlying transaction between the cardholder and the issuer.

In scenarios where, for instance, the ATM network operator is also the issuer, then the term payment processor is understood to define the operational domain where electronic messages in association with the transaction between the issuer and the cardholder are being processed, computed, and or performed.

The consumer/cardholder/user would, during the device verification process of the underlying transaction between the cardholder and issuer, make use of a radio communications apparatus also called the mobile station, portable device, phone, cellular phone, or phone device and the issuer would maintain and operate, a remote server also called the gateway, external node, that would perform the role of message exchange and interface between the issuer and the telecommunications/data network of a separate telecommunications service provider also called the “telco”, the telco further operating and maintaining its radio/data network at least comprising a HLR (home location register) or its equivalent if such a network is not a GSM/CDMA system, a VLR (visitor location register), a MSC (mobile switching center). Other components of the telco's network may include base towers, base station controllers etc.

Card apparatus refers to a card device issued by the issuer to the cardholder and may be either a magnetic stripe card (ISO/IEC 7811, 7812, 8583 etc.), a EMV card (ISO/IEC 7816), a contactless EMV (ISO/IEC 14443), a “smart” card (ISO/IEC 7810), PIN refers to personal identification number and may follow the various encryption, control and management specification of ISO 9564 standard, and further covers various PIN verification schemes such as IBM 3624, PVV “Visa method” etc. Natural PIN refers to the PIN generated by the issuer at the time of print and issuance of the card apparatus to the cardholder.

Cryptographic hash function refers to computer-implemented mathematical steps to convert a given data stream into a digest, and includes but not limited to SHA-1, MD5, NIST SHA-3 etc.

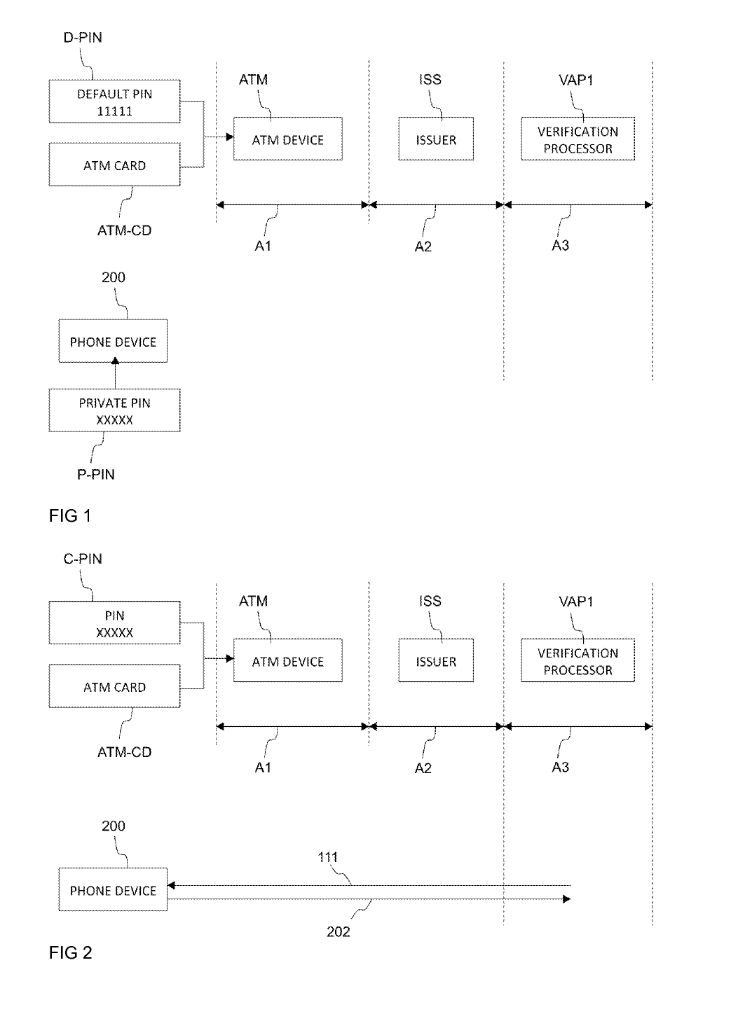

Referring to FIG. 1, a cardholder requires the following in order to use the multi-factor system of this invention:
a) ATM card apparatus labeled ATM-CD,
b) Phone device labeled 200,
c) A default PIN labeled D-PIN and
d) A private PIN labeled P-PIN

Therefore, the cardholder has two physical item (“what you have”) to be used during a pending transaction between an issuer and the cardholder—the phone device 200 and the ATM card ATM-CD, the “what you know” aspect of the cardholder is essentially the P-PIN (private PIN).

The default PIN D-PIN in this example, is “11111” and is issued to a group of cardholders.

This does not mean that all ATM-CD belonging to the group of cardholders are the same, since each of the cardholders have different bank account numbers (commonly termed “primary account number” or PAN), this infers that the offset value are essentially the same for these cards (11111).

The objective of the D-PIN is to allow for interoperability of this application across a plurality of different ATM networks, such as those in a foreign territory.

A multifactor authentication system such as one using RFID or NFC (near field communications), or those involving the use of biometrics, would require every ATM to be standardized in order for the same level of security to be accorded to the pending transaction.

Global standardization of ATM devices to either a RFID or NFC-based authentication regime is unlikely in the near future. However, circumstances where the ATM itself may be compromised would open the prospect where the cardholder's PIN is recorded, the card apparatus cloned and the cardholder's account compromised (thus capturing both “what you have” and “what you know”).

### Terminology of Messages:

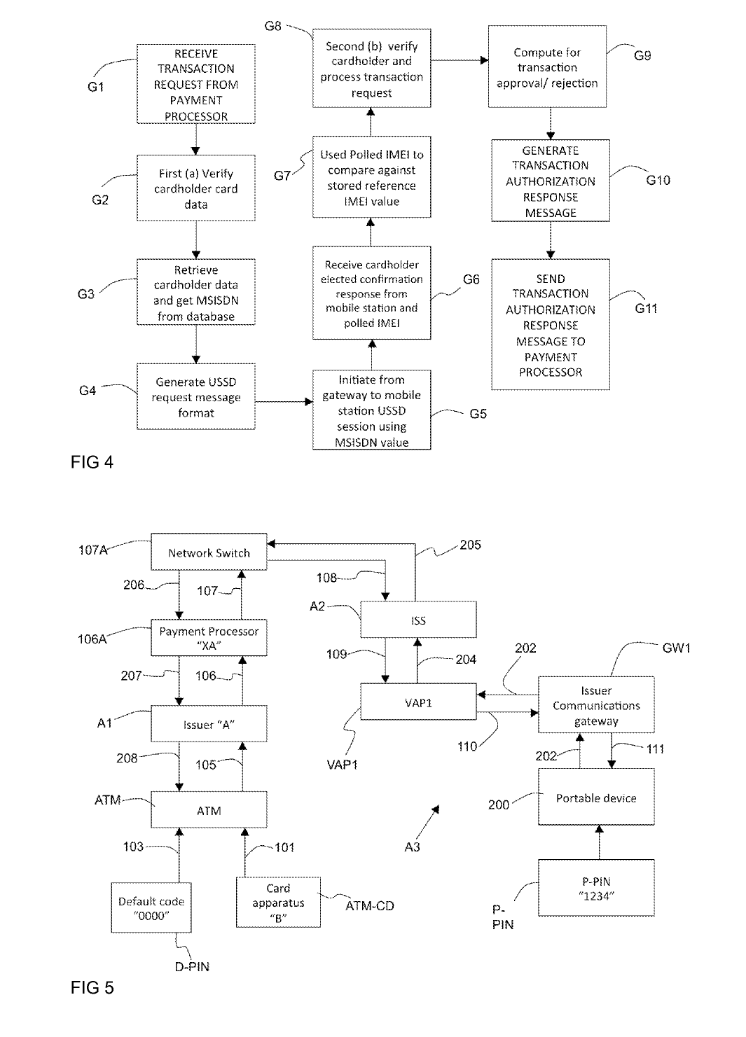

In a non-limiting example, the present application makes use of ISO 8583 (ISO 8583-1:2003), financial transaction card originated messages, with adaptations and variations that are dependent on the transaction-processing environment where the said application is to be implemented, also the message structure, format, data elements and their respective data values may follow ISO 8583 when these messages are to be exchanged to a network domain outside or external to that of the originating issuer network domain (issuer system is labeled “ISS” on FIG. P1 to FIG. 3 for example), the verification request and response messages exchanged within the ISS network domain may at the option of the issuer, follow ISO 8583, or have partial similarities to ISO 8583 with additional adaptations such as new data elements that are only to be utilized within the ISS network domains and the verification processor/transaction processing engine of this invention.

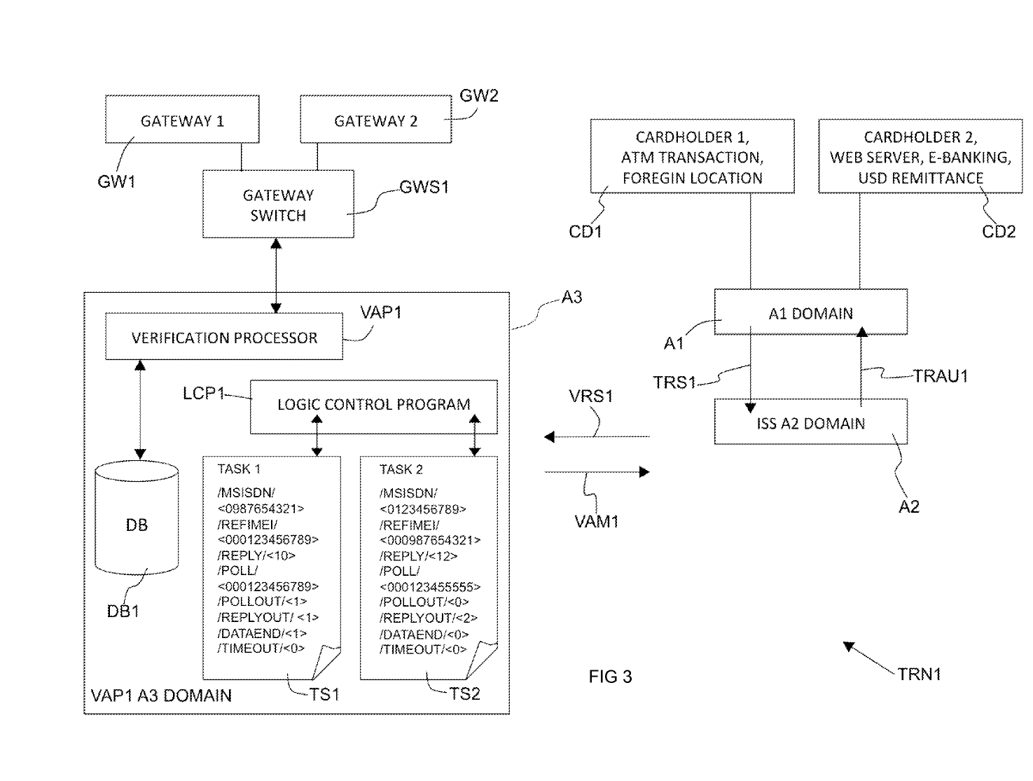

For smart-card/contact card systems such as using the transaction-processing system of this application in the field of user ID-password multifactor authentication, these messages exchanged between the network domains depicted in FIG. 1, FIG. 2 and FIG. 3 may therefore follow ISO/IEC 7816.

Generally, the transaction originating network (such as from that of the ATM etc), generates a transaction request message and sends it to a processor system or device for “online” verification/processing, like this:

Human cardholder inserts ATM card keys in ATM PIN→XYZ ATM device→Transaction request message→processor

“XYZ ATM device” represents both the ATM device and the computer host network (“transaction originating network”) that the ATM device is connected to.

“XYZ ATM device” then waits for a response from the processor, like this:

processor→Transaction authorization message→XYZ ATM device→Human cardholder gets what he/she wants or not.

Generally Transaction request message and Transaction authorization message are constructed to be interoperable between different issuer or payment processor networks.

Within the processor itself, the present application performs in part, verification of the cardholder's associated account and transaction by making use of the following messages:
a. Verification request message,
b. Verification response message.

Generally, the present application receives the following messages;

### Transaction Request/Transaction Request Message

A transaction request is when a cardholder or user attempts to make a transaction with an ATM host network, or an electronic banking application server network, or a debit/credit card network (which is hosting the merchant or card terminal where the cardholder is making the said transaction), it is generated by the network where the cardholder is making the said transaction, and not the cardholder in person, this said network is also collectively called the transaction originating network.

If the transaction originating network is also the network of the issuer entity of the cardholder, then transaction request is utilized by the present application, either partially or in its entirety, also as its verification request/verification request message.

### Verification Request/Verification Request Message

When the issuer entity network of the cardholder receives the transaction request message from a transaction originating network, the present application in operative communication with the issuer entity network utilizes the transaction request message, either partially or in its entirety, as its verification request/verification request message.

The present application then makes use of the verification request to perform the remaining aspects of the multi-factor verification of the cardholder and the associated transaction, and generates a verification response/verification response message back to the issuer network.

### Verification Response/Verification Response Message

When the present application performs and completes the remaining aspects of the multi-factor verification of the cardholder and the associated transaction, the present application generates a verification response/verification response message for use by the issuer entity network. The issuer network makes use of this verification response message and cardholder account data (whether credit is available and sufficient or not, for example), to then generate a transaction authorization.

### Transaction Authorization/Transaction Authorization Message

The issuer entity network makes use of the verification response/verification response message to generate a transaction authorization/transaction authorization message for use by the transaction originating network (such as an ATM host network, or an electronic banking application server network, or a debit/credit card network, which is hosting the merchant or card terminal where the cardholder is making the said transaction).

In some instances the transaction originating network belongs to the same issuer network, in others, belonging to a third party.

In this application, the cardholder's actual PIN (termed private PIN to avoid confusion from the D-PIN) is never entered via the ATM device directly, but on the phone belonging to the cardholder and therefore eliminates the prospect of the PIN being stolen via tampering on the ATM device.

Some or all features of the above explained general embodiments can be combined with one or more of the specific embodiments explained below.

Referring back to FIG. 1, A1 is the network domain where the ATM device labeled ATM is hosted, the issuer ISS belongs to the issuer domain of A2.

Simplified, the ATM domain A1 receives from the ATM device data relating to the cardholder's D-PIN and ATM-CD, generates and formats a transaction request message to send the transaction request message to issuer domain A2.

Only when A1 receives from A2 a transaction authorization message can the ATM device proceed to complete the pending transaction. The issuer ISS will make use of the transaction request message received from A1 to get the cardholder's information such as available cash amount in the cardholder's primary account etc.

In this application, the ISS will also route either part or the complete transaction request message to a verification processor VAP1, which belongs to the domain A3—this means the verification processor VAP1 thus receives the verification request message from ISS.

It should be noted that the domains A2 and A3 may belong to ISS or separate entities, also domains A1 and A2 may have to route and exchange messages (these are TRANSACTION REQUEST and TRANSACTION AUTHORIZATION messages, not to be confused with verification request messages and verification response messages) via another external domain party, such as a ATM network switch (not shown).

The verification processor VAP1 establishes a remote wireless communications link between VAP1 and the phone device 200, and requests from the cardholder input of the P-PIN, this may be implemented by means of a block code stored on the phone 200 that is operable to either encrypt or hash the P-PIN input using a suitable cipher algorithm.

The block code can be loaded onto the phone 200 by a variety of methods, where one such method is FOTA (firmware over the air).

ISS will then generate a transaction authorization message and return to A1 with the transaction authorization message for subsequent execution by the ATM device to complete the pending transaction.

Now, referring to a second mode of this application, and with reference to FIG. 2, a cardholder requires the following in order to use the multi-factor system of this invention:
a) ATM card apparatus labeled ATM-CD,
b) Phone device labeled 200,
c) Cardholder's PIN labeled C-PIN.

It should be noted that in this mode of the application is similar to that of FIG. 1, except that the cardholder performs input of C-PIN via the ATM device itself and not on the phone device 200.

This mode is useful when deployment of a PIN cipher block routine to a plurality of cardholders is problematic or undesirable.

The ATM host domain A1 sends a transaction request message to A2 and waits for a transaction authorization message, the ISS upon receipt of the transaction request message will then instruct VAP1 using a verification request message, to establish a remote wireless communications link with the phone device 200 that is associated with the transaction originating from host domain A1.

The remote wireless communications link is depicted at 202 and 111.

The verification processor VAP1 does two tasks during the communications link session,
(i) presents a plurality of transaction confirmation options for the cardholder to select as an answer to respond to VAP1, and
(ii) polls and retrieves from the phone device 200 its device serial number (such as an IMEI for GSM phones and MEID/ESN for CDMA phones)

The transaction confirmation options that are presented to the cardholder during the communications link resemble the following:

(I) transaction confirmation (cardholder elects this option answer to allow the transaction to proceed)
(II) transaction cancellation (cardholder elects this option answer to request the transaction to be cancelled)
(III) transaction alert request (cardholder elects this option answer to request the transaction to be cancelled and the associated card apparatus to be invalidated)

It should be noted that in the case where the cardholder's account holds insufficient funds to meet the pending transaction amount, and the cardholder still elects (I), “transaction confirmation”, as above, during the communications link, ISS will still cause the transaction to fail (that is to say, generate a transaction authorization message to transmit to the domain A1 of FIG. 1 and FIG. 2 for completing (failing) the pending transaction.)

The verification processor VAP1/ISS, will then perform the following task:
(a) VAP1 to match the polled retrieved device serial number against a stored reference device serial number,
(b) ISS to process and generate a transaction authorization message based on a data derived from ISS (cardholder funds sufficiency checking etc), and the elected cardholder answer (either I, II or III) obtained during the communications link between the phone device 200 and VAP1.

### System Architecture of the Present Invention

Under the general embodiment described in FIG. 1 and FIG. 2, the ISS domain and the verification processor VAP1 contains a transaction processing engine and its related control code.

This transaction-processing engine is described in FIG. 3.

The logic control program residing within the transaction-processing engine of FIG. 3 is also the control code, which is utilized within the transaction-processing engine to make use of the data derived (the polled retrieved phone device 200 device serial number, the cardholder's elected transaction confirmation option answer) to generate a verification response message for use between the ISS A2 and VAP1 A3 domains (for the ISS to generate the TRANSACTION authorization message).

Finally, it should be noted that the transaction-processing engine of FIG. 3 can be utilized with the general embodiment of FIG. 2 in a manner that allows the multi-factor verification system to be used for various transaction applications such as electronic banking, debit-credit card payment, check clearing and confirmation, currency remittance service, in addition to ATM multi-factor authentication.

For example, in the case of electronic banking, the cardholder may perform logon to an electronic banking website using an ID and password. The application server of the electronic banking website would therefore generate or route related data to the ISS a transaction request message, and VAP1 would get from ISS, a verification request message.

The VAP1 A3 domain containing the transaction-processing engine of FIG. 3 would receive from the (electronic banking) application server a verification request message, and the application server would wait for a verification response message, this in one embodiment can entail the inclusion of the ID in the verification request message in order for VAP1 to implement the phone device user verification aspect of the present invention.

In this data processing configuration, VAP1 does not perform authentication of the ID/password—this is still performed by the application server, thus reducing code integration of the overall system with the present application (thus making the present application more “plug-and-play”).

The application server performs its own authentication routine and sends the verification request message to the VP and completes its authentication routine together with the returned verification response message generated from VAP1.

With reference to FIG. 3, a transaction-processing system TRN1 for performing multi-factor verification of transactions between a plurality of users and a verification processor VAP1 is disclosed.

In a non-limiting example, two users are shown in FIG. 3, a cardholder CD1 with a pending ATM transaction, and a cardholder CD2 with a pending electronic banking transaction. Therefore CD 1 and CD2 are transactions created from the transaction-originating network A1 indicated.

Processor VAP1 in operational communication with a database DB1 storing a plurality of verification records, wherein each record having an unique ID and said record containing at least one MSISDN (mobile subscriber ISDN number) value, and at least one reference device serial number value.

The MSISDN value is the respective phone number of each cellular phone device belonging to CD1 and CD2, and MSISDN is also referred to as the MIN (Mobile Identification Number), usually the MSISDN is loosely referred to when describing GSM phone systems while MIN is used for CDMA phone systems, for the purposes of this application and its accompanying specification/embodiments therein, they shall be collectively be referred to as MSISDN and shall mean either the MSISDN or MIN interchangeably.

In the remainder parts of this specification describing the present application, MSISDN can collectively refer to either the MSISDN, or MIN.

The system TRN1 reading from a first memory space TS1 a verification request message and associating said request message to a specified verification record stored on database DB1, in this example, the cardholder CD1 attempts to perform the ATM transaction with a network domain A1, which generates a message routed via TRS1 to the network domain ISS A2, which may be a separate domain from the domain VAP1 A3 hosting the verification processor VAP1, or domains VAP1 A3 and ISS A2 are within the same computational resource (such as a mainframe) and are only logically separated, such as in a application virtualization scheme.

It should be noted that the network domain A1 above generates a transaction request message to send to the network domain A2 of ISS, and a typical transaction request message may resemble the following (data fields are separated by “&”):

TRXTYPE=S&TENDER=C&ACCT=42053981103205100&EXPDATE=0625&CVV2=123&A
MT=99.00 [symbol] AME=Linda&LASTNAME=Carla&STREET=607 Main

| | |
|---|---|
| St.&CITY=LA | &STATE=CA |

PARTNER=Partner [symbol]
indicates data missing or illegible when filed

This transaction request message contains the transaction type, payment method, the cardholder's card information etc.

The verification processor VAP1 does not need to use all of the data contained in the transaction request message above, and may therefore read from the transaction request message data it would require for processing.

The processor VAP1 collects the needed data as above which constitutes the verification request message.

A typical verification request message (partial) may resemble the following:

TRXTYPE=S&TENDER=C&ACCT=42053981103205100&EXPDATE=0625&CVV2=123&A

| | |
|---|---|
| MT=99.00 | &COMMENT1=Reservation& |

The processor VAP1 would then make use of, in this example, the cardholder's primary account number (which in this case is the credit card number), to then retrieve the cardholder's MSISDN value from a related database DB1.

| Primary account number | | reference |
|---|---|---|
| extracted | retrieved MSISDN value | device serial |
| 42053981103205100 | 01212000276554 | 983456783321236 |

The processor VAP1 may then load and format the verification request message as follows:

TRXTYPE=S&TENDER=C&ACCT=42053981103205100&EXPDATE=0625&CVV2=123&A

| | |
|---|---|
| MT=99.00 | &COMMENT |

83321236&

The verification request message above thus includes the retrieved MSISDN value and the reference device serial number under the header GW1VER and GW1VERD (see above sample text string).

Cardholder CD2 attempts to perform the electronic banking transaction with domain ISS A2 which may contain a web application server hosting the electronic banking application, the electronic banking application therefore sends a message via TRS1 to the domain ISS A2. TRS1 may be a high-speed data trunk, for example.

The transactions related to CD1 and CD2 can only be completed (either approved, or fail), when the respective electronic banking application and ATM transaction each receive an authorization message via TRAU1. TRAU1 may be also part of the same high-speed data trunk of TRS1.

The verification processor VAP1 allocates the first memory space TS1 for transaction related to CD1, and second memory space TS2 transaction related to CD2. In each memory space contains the verification request message related to each transaction CD1 and CD2.

To perform verification of cardholder CD1 and CD2, the verification processor VAP1 is operationally connected to a plurality of gateways such as GW1 and GW2. In large-scale systems, the plurality of gateways GW1, GW2 may be connected to a gateway switch application GWS1, in order to provide scalability, or to allocate specific gateways to handle different groups of applications such as example CD1 and CD2.

In one embodiment of the present application, a gateway switch is in operational communication with a plurality of gateways and each gateway providing session handling data (meaning the number of established messaging sessions the particular gateway is performing at the measured time span) to the gateway switch.

Referring to FIG. 3, gateway switch GWS1 is connected by means of a data link to gateway GW1 and GW2, each gateway (GW1 and GW2) providing session handling data, which may resemble the following:

0054 00032 00100

The above data packet comprises the first four digits identifying the gateway (either GW1 or GW2) to the switch GWS1, while the second five digit number group provides the total number of messaging connections the gateway is handling (this is case it is given as 32) whereas the final five digit number group provides the total number of messaging connections the gateway can handle.

Optionally, the data packet can also be constructed with message headers as follows:

16 64 0054 00032

In the above example, the first two digit number groups are the message headers the first being the numeral code the gateway provides as indication of the availability of service, for instance,

| Message header | service | action to be taken by |
|---|---|---|
| code | status | the gateway switch (GWS1) |
| 16 | full | allocation job to next available gateway |
| 17 | ready | allocation job number XXXXXX to 0054 |

The gateway switch GWS1 can, under peak or stressed load cycles queue non-allocated jobs waiting for a gateway to become available.

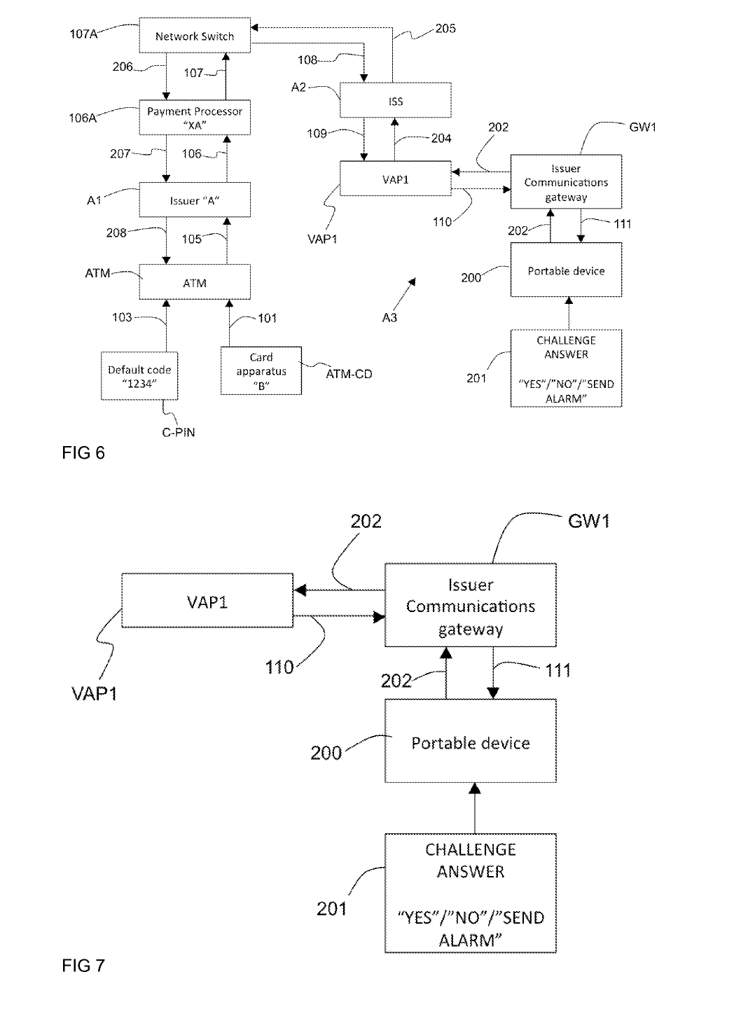

With reference to FIG. 4, a payment processor receives a request message from a user, and using the contents of the request message the payment processor obtains cardholder related data about the user from one or more database.

Based on the user's related cardholder data and request message received, the payment processor generates a USSD message and sends the USSD message to the cardholder's cellular device that has been made known to the payment processor earlier (such as when the user is enrolled and registered with the payment processor).

The payment processor is further configured to electronically poll from the cardholder's cellular device for its IMEI number and compare the polled IMEI number from a stored value from one or more database that is operationally in communication with the payment processor.

The payment processor will await a response from the cardholder in the form of a reply message that is transmitted by the user through the said cellular device during the USSD message session, and generates a transaction message that will either perform one or more functions in relation to the underlying transaction that is related to the request message received by the payment processor.

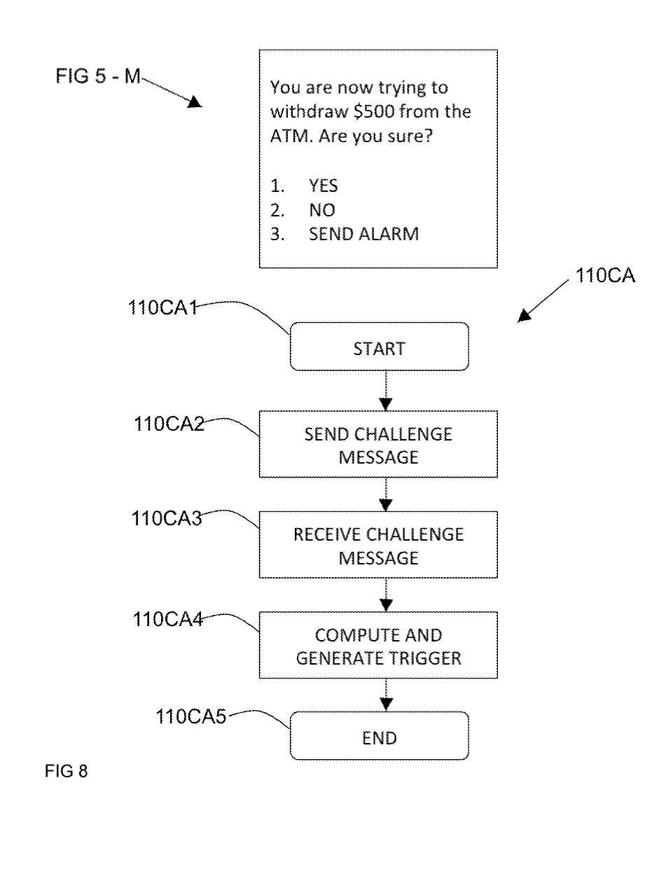

With reference to FIG. 5, the ATM issuer receives from a designated ATM device about a cardholder's request for the transaction to be performed. The card apparatus that is utilized by the cardholder contains data and information that is utilized by the ATM issuer, including a default PIN code that is commonly issued to all similar cardholders of the ATM issuer.

This means that the ATM issuer may, for example, issues 10,000 ATM cards to 10,000 individual cardholders, all having unique information pertaining to each cardholder, including unique off-set codes.

However, all 10,000 cardholders are given the same PIN code (a ‘universally known’ PIN such as 000000).

It does not mean that each cardholder shares the same offset PIN value.

The ATM issuer will obtain from one or more database that is in operational communication with the ATM issuer details about the particular cardholder that is requesting the impending ATM transaction.

The details includes a prearranged cellular number to which the ATM issuer will initiate a USSD session with the cardholder through the prearranged cellular number (and device) to gather one or more responses from the cardholder.

In another embodiment, the USSD session may be a real-time messaging session between the cardholder and the ATM issuer, such as a real-time messaging computer routine that may be installed on the cardholder's prearranged cellular device to be able to securely communicate with the ATM issuer.

The objective of this embodiment is to cause the ATM card apparatus of the cardholder to be rendered useless even in the event of the loss of the card apparatus, since the transaction cannot be completed unless the cardholder respond with an appropriate content back to the ATM issuer on the device that is enrolled earlier with the ATM issuer.

In yet another embodiment, the ATM issuer may issue regular ATM card apparatus to all its cardholders that have unique PIN codes and unique PIN offset values, except that the transaction cannot be completed unless the ATM issuer is able to retrieve the prearranged cellular number and receive the correct cardholder response from each electronic messaging session or USSD session.

In another embodiment, this feature may be activated for ATM transaction requests that are marked, such as when the ATM issuer detects that the ATM card apparatus is being utilized at an ATM device that is outside the country of the cardholder, or when the ATM transaction request is beyond a pre-determined amount, or when certain types of ATM transactions are requested by the cardholder.

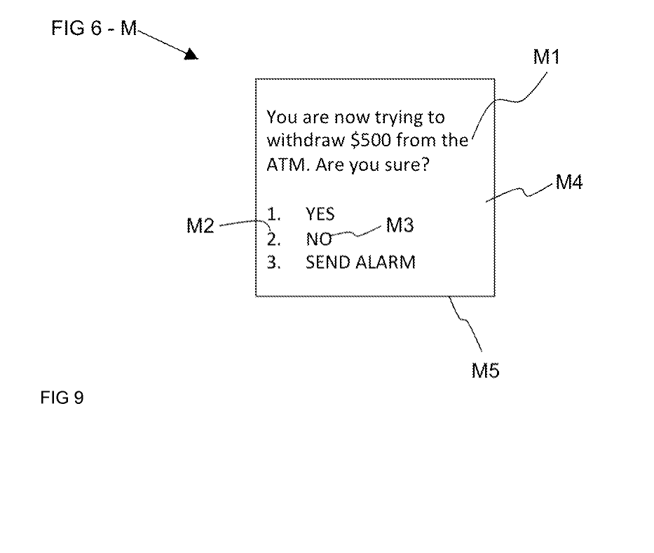

With reference to FIG. 6, in this embodiment, the ATM issuer sends a response message either through a instant messaging computer application that is installed on the cardholder's device, or initiates a USSD session, and provides the cardholder with the ability to cause each impending ATM transaction request to be accepted, cancelled, or to be cancelled and an alarm signal be sent so as to cause de-activation of the ATM card apparatus thereby providing additional security for the benefit of the ATM cardholder.

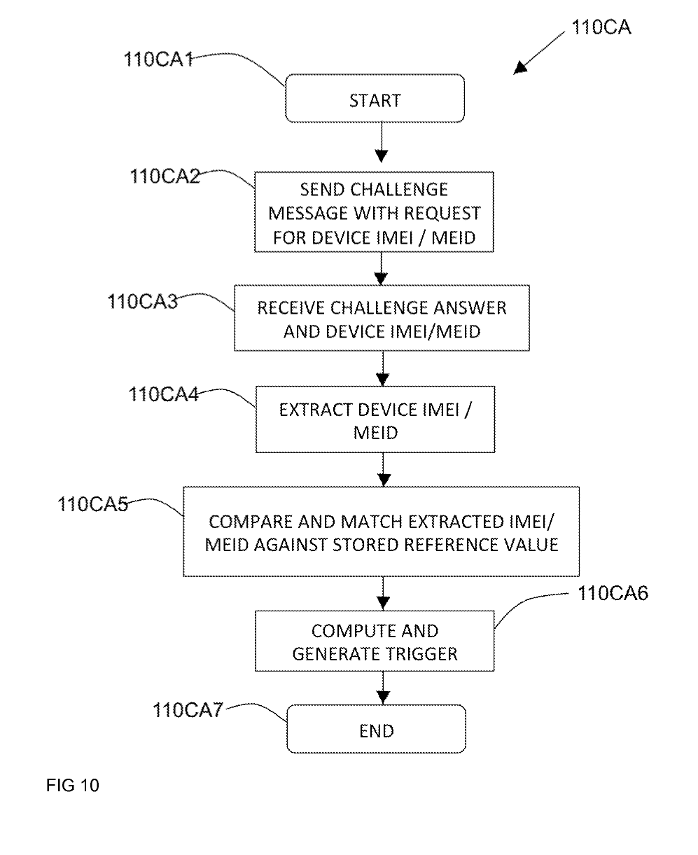

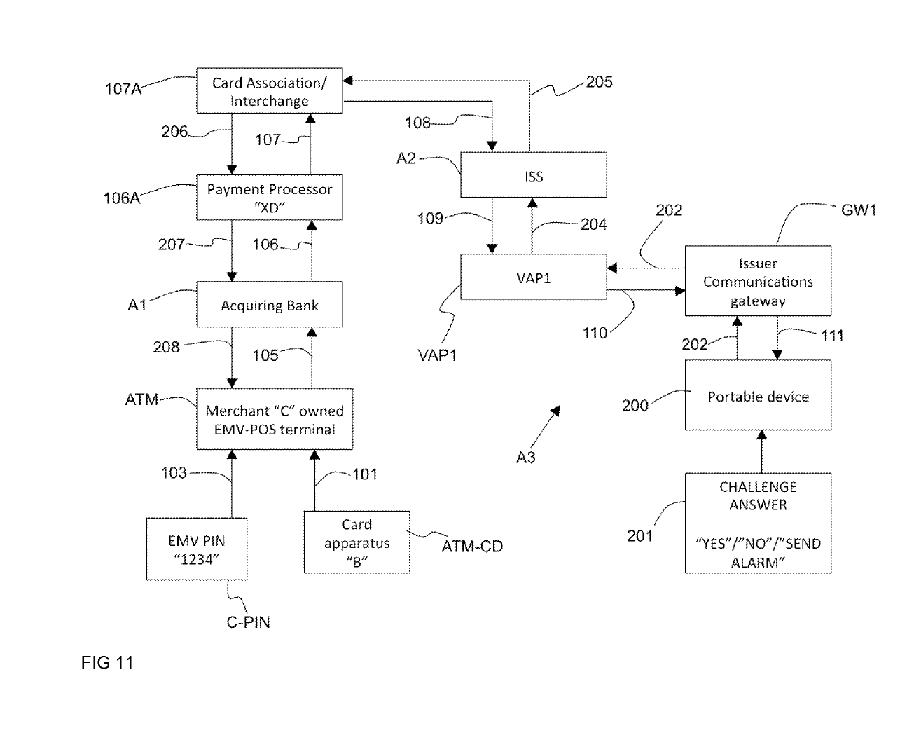

With reference to FIG. 3, FIG. 7 and FIG. 8, verification processor VAP1 of FIG. 7 initiating a remote wireless communications link to a phone device 200 associated with said specified verification record MSISDN value and sending a user input request message 201 to said phone device 200.

The user input request message 201 may contain a plurality of individual transaction options (or user transaction choice), each tagged with a identifier code, and may resemble the menu in FIG. 8 labeled FIG. 5-M.

This transaction options in FIG. 5-M are:

| Name of option | Tagged identifier code |
|---|---|
| YES | 1 |
| NO | 2 |
| SEND ALARM | 3 |

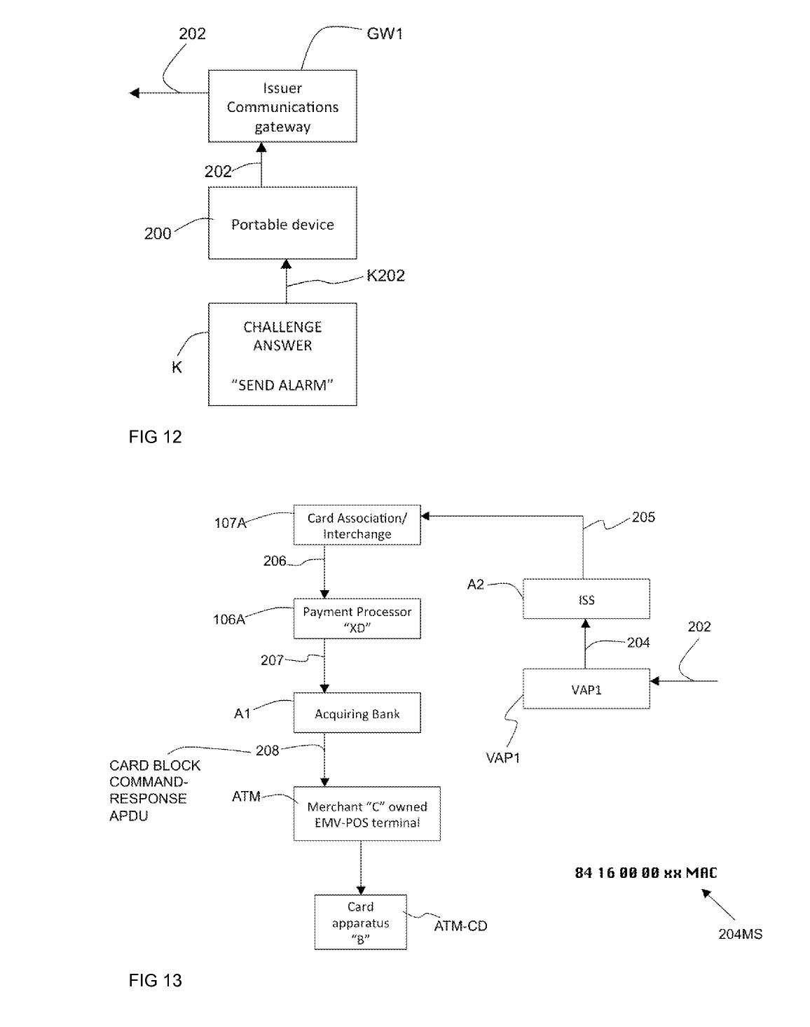

The cardholder CD1 inputs the identifier code that matches the cardholder's intent via the phone device 200 keypad and sends the transaction confirmation option answer back to the gateway GW1, for instance, if the cardholder CD1 wishes to cancel the transaction the input via the keypad would be “2”—this would therefore be the user input message 202 of FIG. 7. With reference to FIG. 8 and FIG. 9, the menu of FIG. 8 may be explained in greater detail in FIG. 9 where the menu labeled FIG. 6-M, contains a user input request message 201, having a text body M1 informing the cardholder the transaction amount to be confirmed, and a plurality of transaction options, depicted is one such said option labeled M3 with its accompanying identifier code M2.

The menu FIG. 9-M of FIG. 6 of the user input request message 201 (of FIG. 7) is contained and displayed within the screen space of M4 of the display unit M5 of the cardholder's phone device 200.

In the above example, when the cardholder phone device receives the message 201, this message comprises of a plurality of different options resembling M3, each said option having their own unique identifier code M2.

In one embodiment of the present application suitable for performing multi-factor verification of debit-credit card transactions, and or electronic banking transactions, verification processor VAP1 of FIG. 7 is operable to send a user input request message 201 to the phone device 200 and the message 201 contains a input request prompt from the gateway GW1 for the cardholder CD1 to input a card security code, or CVV2, or the CVC2 code.

The cardholder inputs the requested security code via the phone device 200 keypad and the gateway GW1 routes the said code back to the processor VAP1.

In one mode of the present application, verification processor VAP1 sends a command routine 111 during the said communications link to poll from said phone device 200 a retrieved device serial number value.

For GSM, WCDMA phone devices this is the IMEI (international mobile equipment identity), while for CDMA, iDEN phone devices this is the ESN (electronic serial number) or MEID (Mobile Equipment Identifier).

In GSM or WCDMA systems where the gateway GW1 establishes the said communications link, the command routine “AT+CUSD” is utilized to poll and retrieve the device serial number such as its IMEI (international mobile equipment identity) number value.

In CDMA systems the gateway GW1 may utilize the “AT+CGSN” or “AT+GSN” command routine to poll and retrieve the ESN (electronic serial number), device serial number or MEID (Mobile Equipment Identifier).

With reference to FIG. 10, this command routine may be transmitted at either stage 110CA2 or stage 110CA3, or both. In one embodiment of the present application, the user input request message labeled FIG. 6-M in FIG. 9 may be tagged with the command routine described above in such a way that whichever identifier such as M2 is chosen by the cardholder to send the elected option back to the gateway, it also performs the step of polling and retrieval of the phone device's device serial number.

In another embodiment of the aspect described in FIG. 10, and at stage 110CA2, the command routine may be transmitted separately but during the USSD (Unstructured Supplementary Service Data) service session between the gateway GW1 and the phone device 200.

Referring to FIG. 7, verification processor VAP1 receiving from phone device during said communications link a user response message 202, the cardholder CD1 of FIG. 3 inputs the desired transaction confirmation option answer (“2”) of FIG. 9 and sends the answer to the gateway GW1 of FIG. 7 which routes the message 202 to VAP1.

The transaction-processing system of FIG. 3 reading from verification processor VAP1 said retrieved device serial number value and performing a function call to match retrieved device serial number value against the reference device serial number value to generate a function call result value, this function call result value may be a “1” or “0” indicative of where there is a match or not, and the verification processor VAP1 would generate a verification response message using the function call result value (assumed “0”) and the cardholder CD1 elected transaction confirmation option answer (assumed “2”).

The transaction-processing system generating a verification response message using said function call result value and said received user response message, the said system further writing the generated verification response message to said first memory space TS1, the first memory space TS1 is in operational communication with the ISS A2 domain, in a manner allowing the ISS domain to use the verification response message directly, or, in another mode, generate a authorization message for transmittal to the domain A1 of FIG. 3.

The verification response message may resemble the following:

TRXTYPE=S&TENDER=C&ACCT=42053981103205100&EXPDATE=0625&CVV2=123&A

| | |
|---|---|
| MT=99.00 | &COMMENT1=Reservation&GW1F |

Note that the function call result value and the cardholder's elected transaction confirmation option answer in the above example are included under the two headers:

GW1FCAL and,

### GW1INT

The ISS within the domain A2 will therefore read from, or receive from processor VAP1 the verification response message and generate the transaction authorization message for transmittal to domain A1, and the transaction authorization message may resemble the following:

RESULT=1&PNREF=EFHP0D426A53&RESPMSG=DECLINED&AUTHCODE=29TEST&A
VSADDR=Y&AVSZIP=N&CVV2MATCH=

In the above transaction authorization message the transaction is failed.

In yet another mode of the present application, the ISS domain and the A1 domain may be operationally connected or are within the same domain (they may be applications in separate logical spaces such as in a mainframe/server virtualization resource configuration).

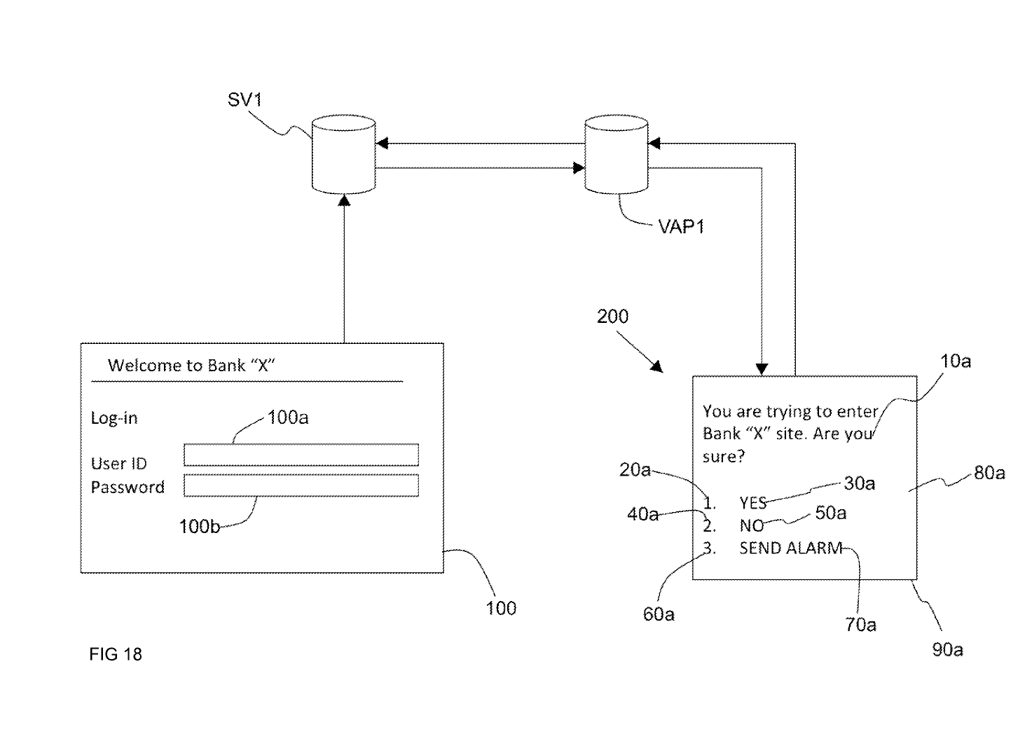

Now referring to FIG. 17, an embodiment for implementing cardholder input request message 100 and 200, transcoding is herein described as follows:

The issuer determines the structure of the plurality of unique transaction choices that are offered to the user or cardholder during each transaction attempt verification step in the form of the selected USSD message that is transmitted from the issuer (via the gateway) to the target mobile user (which is either the user or the cardholder).

Generally, these transaction choices remain fairly uniform during each transaction attempt verification step for the plurality of target mobile users—for instance, the “usual” choices offered are “YES” (to confirm the transaction) at 30a, 30b, “NO” (to cancel the transaction) at 50a and 50b and “ALARM” (to cancel the transaction and raise notification to issuer, for example) at 70a and 70b.

The various unique transaction choices (“YES”, “NO”, “ALARM”) are transcoded with a set of unique identifying codes (as shown in 20a, 20b, 40a, 40b, 60a, 60b):

| Name of option/choice | Identifier code |
|---|---|
| YES | 1 |
| NO | 2 |
| ALARM | 3 |

In one embodiment of the present application, the issuer comprising a verification processor or system that is operable to cause a one-time unique identifier code to be transcoded to each uniform transaction option or transaction choice for each USSD message prepared for transmittal to the target phone device of the target user or cardholder or target mobile user. This transcoding can also adjust the character set in order to display to the user a preferred language, for instance, Mandarin, Hindi, Swahili, Nordic languages such as Nynorsk, Russian, etc.

For example, if there are a total of 4 transactions the target mobile user makes within a measured time period, then they resemble the following tables:

TRANSACTION ATTEMPT #1

| Name of option/choice | Identifier code |
|---|---|
| YES | 1 |
| NO | 2 |
| ALARM | 3 |

TRANSACTION ATTEMPT #2

| Name of option/choice | Identifier code |
|---|---|
| YES | w |
| NO | g |
| ALARM | b |

TRANSACTION ATTEMPT #3

| Name of option/choice | Identifier code |
|---|---|
| YES | ft9 |
| NO | fw1 |
| ALARM | k7a |

TRANSACTION ATTEMPT #4

| Name of option/choice | Identifier code |
|---|---|
| YES | 00a |
| NO | tt1 |
| ALARM | z |

The tables above therefore shows the transaction attempts having uniform transaction options or transaction choices and each choice being transcoded with a one-time identifying code, for instance, table for TRANSACTION ATTEMPT #3 shows the “NO” transaction choice being transcoded with the identifying code “fw1”, which differs from the identifying code that is transcoded with the same transaction choice type in TRANSACTION ATTEMPT #4.

The unique identifying code may be generated in a manner such that the code is derived and tied to the specific transaction being attempted, for instance, implementing an attack on the system using the unique identifying code with all other verification factors being satisfied cannot be authorized as the time, issuer server random transaction ID, merchant or transaction ATM/POS terminal address cannot be consolidated.

Referring to FIG. 3, in yet another mode of the present application where the transaction-processing system is performed asynchronously, the verification processor VAP1 having the memory space TS1 contains the verification request message and the verification response message.

Transactions CD1 and CD2 are each in operative communication with the network domain of A1, and network domain A1 generates the individual transaction request related to CD1 and CD2 for transmittal from network domain A1 to network domain A2. The transaction requests related to CD1 and CD2 are transmitted via TRS1.

The network domain A1 will only proceed to complete each transaction CD1 and CD2 upon receipt of their corresponding transaction authorization. Transaction authorization of CD1 and CD2 are transmitted via TRAU1. The verification processor VAP1 residing within the network domain A3 will read from first memory TS1 the verification request derived from the transaction request.

In network topologies where the network domains A1 and A2 belong to the same issuer, then network domains A1 and A2 may be a singular network domain, or reside on a single computational resource (such as a mainframe/server), the transaction request would therefore contain data and flags to which the verification processor VAP1 would utilize as part of its verification request message, and both network domains of A1 and A2 share the memory space TS1, or both have access to the memory space TS1. It should be noted that memory space TS1 has an address range allocated for the verification request, and another address range for the verification response, an address range also allocated for the transaction request, another address range for the transaction authorization.

Under a distributed application network topology operated by a single issuer, domains A1 and A2 may reside on separate computational resource (different mainframe/server farm), the transaction request residing on network domain A1 would contain data and flags to which the verification processor VAP1 would utilized as part of its verification request message.

In a distributed application network topology where network domain A2 is the issuer related to transaction CD1, CD2, and network domain A1 is the third party operator hosting the ATM device related to CD1 and the electronic banking application related to CD2, the network domain A1 receives transaction attempts CD1 and CD2, generates their appropriate transaction request for transmittal via TRS1 to network domain A2.

The first memory space TS1 of the verification processor VAP1 of network domain A3 is therefore in operative communication with the network domain of A2, where the verification processor will execute its next stored routine step when the appropriate flag is set from the verification request message VRS1 that is derived from the transaction request received from network domain A1 via TRS1.

The network domain of A2 would therefore derive data from the verification response generated by the verification processor VAP1 and then generate the transaction authorization message for transmittal from the network domain of A2 to A1 (third party operator).

In the case of a TCP/IP or packet-based network connection between the network domain of A3 and A2, then the flag in verification request message VRS1 may be in the message header itself or be contained in the data block of the said message.

In another mode of the present application, the network domain A3 and network domain A2 are in operative communication with the memory space TS1.

In another mode of the present application, verification processor VAP1 has the first memory space TS1 having an address range containing the verification request, another address range containing the verification response. The verification processor VAP1 operationally connected to a transaction network domain which may be a ATM (automated teller machine) host network, a debit-credit card processing network, a user ID-password authentication server network, an electronic banking application network, or a currency remittance transaction network.

The memory space TS1 may be on RAM (random access memory), or be stored on permanent storage such as a database or transaction file.

A review of the transaction request message and verification request message shows common data fields:

Transaction Request Message Received from Network Domain A1:

TRXTYPE=S&TENDER=C&ACCT=42053981103205100&EXPDATE=0625&CVV2=123&A

| | |
|---|---|
| MT=99.00 | &FIRSTNAME=Linda&LAST |

| | |
|---|---|
| St.&CITY=LA | &STATE=CA |

PARTNER=Partner

### Verification Request Message Generated by Processor VAP1:

TRXTYPE=S&TENDER=C&ACCT=42053981103205100&EXPDATE=0625&CVV2=123&A

| | |
|---|---|
| MT=99.00 | &COMMENT1=Reservation& |

Verification Request Message Generated by Processor VAP1 with Retrieved MSISDN Value:

TRXTYPE=S&TENDER=C&ACCT=42053981103205100&EXPDATE=0625&CVV2=123&A

| | |
|---|---|
| MT=99.00 | &COMMENT |

83321236&

### The Verification Response Message Generated by Processor VAP1:

TRXTYPE=S&TENDER=C&ACCT=42053981103205100&EXPDATE=0625&CVV2=123&A

| | |
|---|---|
| MT=99.00 | [symbol] NT=2& |

[symbol]

indicates data missing or illegible when filed

### The Transaction Authorization Message Generated by ISS for Transmittal to Network Domain A1:

RESULT=1&PNREF=EFHP0D426A53&RESPMSG=DECLINED&AUTHCODE=29TEST&A
VSADDR=Y&AVSZIP=N&CVV2MATCH=

In one embodiment of the present application, within the transaction-processing system and the processor VAP1 each transaction is allocated a memory space (TS1, TS2 and so on), and each memory space contains the respective verification request, verification response, transaction request and transaction authorization messages.

In one embodiment of the present application, the transaction-processing system and the processor VAP1 has a memory space TS1 that contains the respective verification request and response messages, and the transaction request and authorization messages reside on a separate computational device/resource.

However, this said separate computational device/resource above shares common data (in the above example this can be the primary account number) that can be utilized to logically link the verification request/response message pair to the transaction request/authorization message pair. This is also defined as the said computational resource being operationally connected or in operative communication with the transaction-processing system and memory space TS1.

For clarity, a transaction-processing system wherein first memory space is in operative communication with at least one network domain selected from the group consisting of an ATM (automated teller machine) host network, a debit-credit card processing network, a user ID-password authentication server network, an electronic banking application network, a currency remittance transaction network would mean that the transaction-processing system and its memory space TS1 shares common data such as the primary account number of the cardholder CD1 (in the example the primary account number is ACCT=42053981103205100) with the said network domain.

For instance, if the transaction originating network (example, ATM host network) does not belong to the issuer (which operates the verification processor, gateway switch and gateways), then, the first memory space belonging to the issuer is in operative communications with the transaction originating network during the transmittal of a completed transaction authorization message from the issuer to the transaction originating network, it does not mean that both networks “share” a memory resource (such as disk storage, RAM etc.).

In the instance where the transaction originating network does belong to the issuer also, the first memory space is defined as being in operative communication with the transaction originating network either by both networks sharing the first memory resource (both having access to a disk storage unit for example), however, in some network topologies (such as when both networks are geographically distant from each other), then it is understood that the first memory space is in operative communication with the transaction originating network by means of a data connection.

In another embodiment, the said network domain above may create a transaction identifier number or value to exchange between the said network domain and the transaction-processing system's first memory space TS1, and thus this would also mean that the first memory space TS1 is in operative communication with the said network domain.

Example of using the present application for electronic banking and general computer network logon access verification

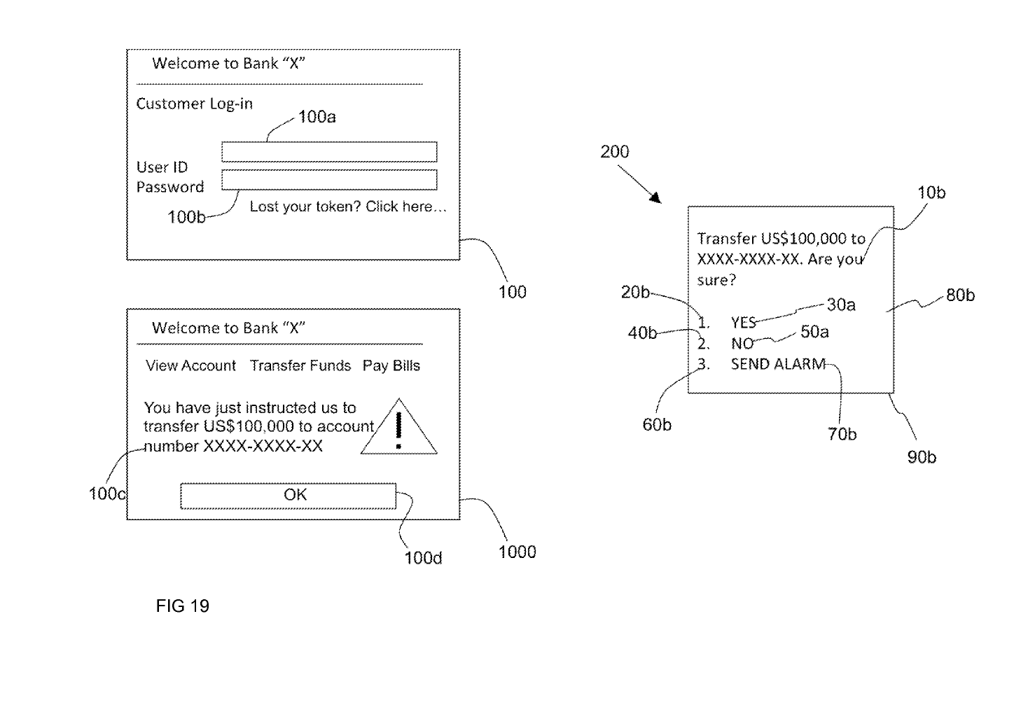

Referring to FIG. 18, an electronic banking access application 100 is shown and in operative communication with the access application host network SV1, a registered user attempts a logon by performing input of user ID information at 100a and related password (or authentication) data at 100b. The authentication of 100a and 100b is still implemented using host network SV1, however, SV1 now requires an additional authentication part to be performed by sending a request to verification processor VAP1, which is operable to send a user input request message 200 to the user's target mobile phone device, the message 200 containing a notification 10a and a plurality of unique options at 30a, 50a and 70a each option transcoded with a unique text identifier code of 20a, 40a and 60a.

Input of one of the said identifier code by the user and the return of a response message containing the code (either 20a, or 40a or 60a) will be read by VAP1 and the result communicated to SV1. SV1 computes the authentication data of 100a, 100b and the received response code and any other collected information from VAP1 against a reference data pool related to the said user and either grant or deny access to the user.

The method described in FIG. 18 can be applied to a generalized computer network environment where a plurality of users have logon credentials and attempts each logon to gain access to the computer network in a similar manner.

The said identifying codes shown in FIG. 18 can be transcoded in similar manner as the ones described in FIG. 17 where the transcoded identifying codes are one-time unique codes.

Referring to FIG. 19, an alternative electronic banking access method is described whereas the user attempts a logon to the electronic banking access application 100 by performing input of the user's ID at 100a and authentication data at 100b, which may be a password, or a one-time PIN or authentication data, depending on the way the application 100 is designed.

The application 100 grants access to the user and certain specific actions taken by the user, in this case, at the specific task attempted by the user at 1000, the application receives a task attempt or request 100c which is stored as a flagged event with application 100, which the user submits to the application 100 using the function at 100d. For example, if the user attempts to make a fund transfer exceeding a pre-set limit to an external bank account not belonging to the user, this may be a flagged event that will trigger a application 100 request to processor of VAP1 (FIG. 18) to perform the additional verification part, comprising of VAP1 sending a message of 200 containing a notification 10b and a plurality of unique options 30b, 50b and 70b each option transcoded with their accompanying and unique identifying codes of 20b, 40b and 60b. The flagged event of application 100 will be granted only if said application 100 receives a valid response data from VAP1.

### EMV Card Example

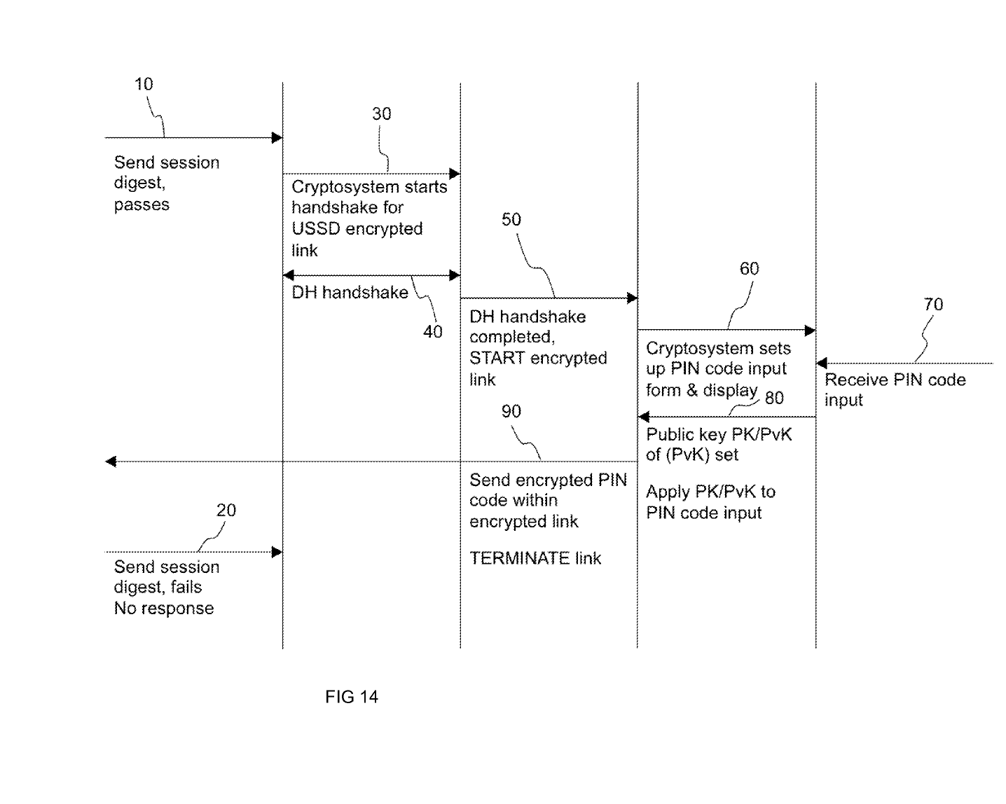

With reference to FIGS. 11, 12 and 13, is disclosed one embodiment of the present application where a EMV card (ISO/IEC 7816-3) is utilized.

A cardholder using card apparatus ATM-CD of FIG. 11 with a merchant terminal labeled ATM elects to input a PIN code of C-PIN. Data contained in the EMV card apparatus ATM-CD and the data indicative of the PIN code C-PIN are transmitted at data points 103 and 101, and both 101 and 103 may be of the same data exchange connection.

In the case of an ATM (automated teller machine) transaction, the embodiment is identical except that the merchant terminal labeled ATM is the ATM device that is connected to its ATM host network of A1, while in the case of the merchant-cardholder transaction scenario, domain A1 is the host network of the merchant's bank.

Network domain A1 receives the data contained in 103 and 101 and generates a transaction request for transmittal to payment processor at 106A, the transaction request message transmitted via data connection 106. This is in the case where the cardholder's issuing bank is not the same bank of that of the host network A1. Assuming the transaction is originating from a cross border location (example, outside the home country of the cardholder), then a switch at 107A may be further responsible for routing the transaction request message to the issuer belonging to the cardholder.

The issuer in this case is depicted at A2 network domain, where it receives the routed transaction request message at 108. Internally, the issuer would facilitate specified data derived from the transaction request message (such as the primary account number of the cardholder and the transaction amount), to be transmitted to the verification processor of VAP1. This is transmitted via data connection 109.

The verification processor VAP1 using the derived data, now logically the verification request message, makes use of a database containing the MSISDN of the transaction originating cardholder to make a USSD messaging service session via the gateway at GW1.

It should be noted that in one embodiment of this application, the verification processor may be operationally connected to a gateway switch (not shown). This switch in turn is in operative communications with a plurality of individual gateways (not shown).

A similar gateway switch arrangement described above can be referenced at FIG. 3, where gateway switch GWS1 is shown, connected to a plurality of gateways GW1 and GW2.

Load balancing can now be implemented where each gateway GW1, GW2 has a throttling rate (example, 5 USSD messages per second), if GW1 is busy, the throttling rate may be 5 out of 5 USSD messages and any additional request for USSD sessions would cause the gateway to begin queuing these “jobs”, thus potentially causing performance latency. The gateway switch GWS1 may also be operable to receive or read from each gateway GW1, GW2 any fault data, in addition to this throttling rate as being indicative of the message throttling rate traffic (hence how busy or available each gateway is).

The fault data may also indicate a serious problem such as the gateway being restarted, not connected or taken out from the network of GWS1.

Now referring back to FIG. 11, the gateway GW1, in one embodiment of the present application, routes transaction amount data and a user input request message 111 to the cardholder's phone device 200.

The user input request message 111 may be displayed on the display unit of the phone device 200 as depicted at 201. The input message depicted at 201 may also be depicted at FIG. 9 as an indicative example wherein FIG. 6-M shows the layout of the input message 111 of FIG. 11. Referring back to FIG. 9, the transaction amount may be shown at M1, and a plurality of different input options, with one being shown at M3, with its accompanying identifier code M2.

The cardholder elects the identifier code M2 and sends back to the gateway a user response message containing the code M2 to indicate to the verification processor VAP1 of FIG. 11 the cardholder's intent regarding the transaction.

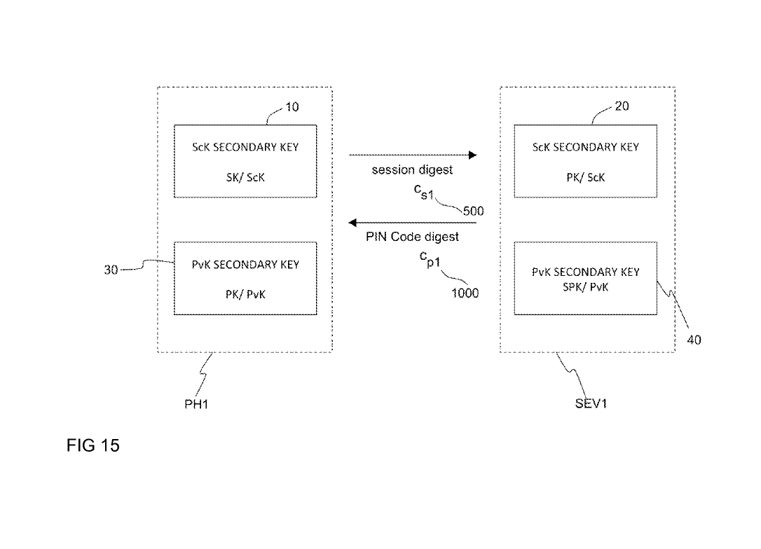

In one embodiment of the present application and referring to FIG. 12, one of the input options of user response message K202 includes a user alert request labeled “K”, wherein the EMV card is instructed by the cardholder to be invalidated.

This allows the cardholder to cancel the EMV card apparatus ATM-CD in the event where the card apparatus is lost, yet a transaction is being attempted by an unauthorized person.

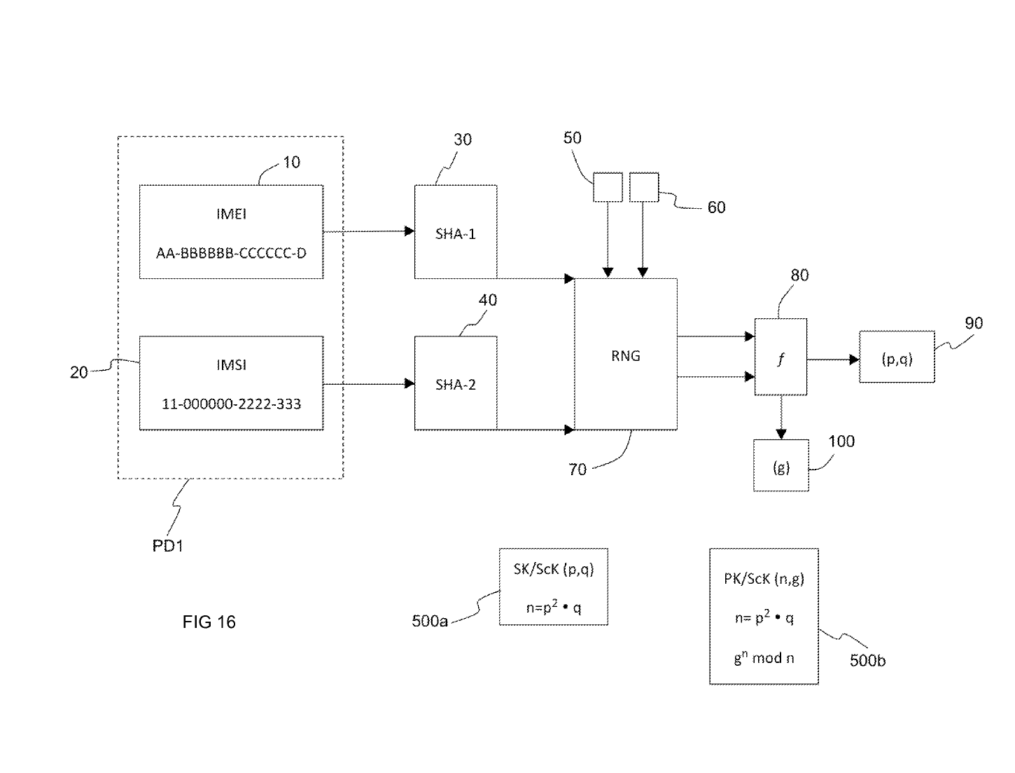

The user response message is transmitted from the phone device 200 to the gateway GW1 via 202. Now referring to FIG. 13, the EMV card ATM-CD may be cancelled and no longer be associated by the issuer domain A2, and additionally, the issuer domain A2 transmits a APDU script (command routine for EMV cards) to further cause card invalidation at the transaction originating network (where the unauthorized person is attempting to make the transaction).

One example of such a APDU command is shown at 208 of FIG. 13, while the system-level script instruction may resemble 204MS, which is generated and transmitted at 205. (204 shows the transmittal of the alert request message from the cardholder's phone 200 via the gateway GW1).

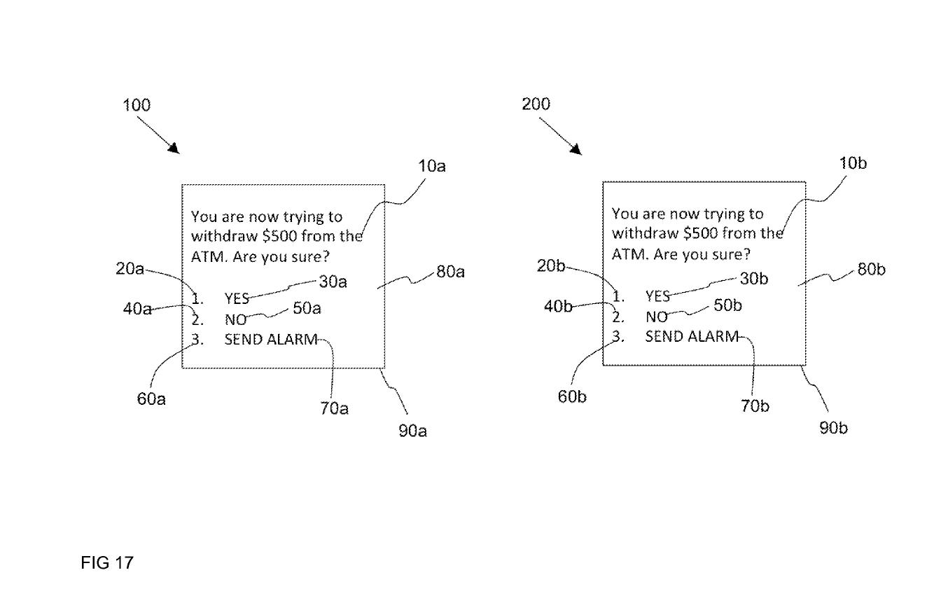

With reference to FIG. 14, FIG. 15, and FIG. 16, a block code encryption scheme to disclosed for financial transactions.

In FIG. 14, a general flow of a typical embodiment of the present application is herein described, where a session digest 10 is transmitted from a gateway to the cardholder or user phone device. From the phone device, it has no means to know if the gateway is a legitimate and authorized machine operated by the issuer to which the cardholder or user has a pre-arrangement.

If the phone device storing its cryptographic facility (a routine code block installed on the phone device either via a URL download, firmware over the air “FOTA”, etc), begins its regular handshake data exchange in order to establish and set up an encrypted USSD session or some other data communications link between the phone device and the gateway, then in the instance of a man-in-the-middle (MITM) attack, the encryption scheme deployed to set up the encrypted USSD session may be compromised.

It should be noted that within the handshake procedure (in networking it may be referred to as transport layer security or TLS), essentially a data exchange between the phone and the gateway (and its connected verification processor belonging to the issuer) for both phone and gateway to choose which cipher to use in order to set up the encryption deployed for the encrypted USSD link.

Given sufficient resources, a series of “requests” coming from an unauthorized USSD gateway, for example, may be able to gather the list of ciphers that are exchanged.

Therefore, the present application makes use of a “pre-TLS” or “pre-handshake” procedure where a session digest is transmitted to the phone device as depicted in FIG. 14, 10. The cryptographic facility uses a Secondary Key (ScK) Set to determine if the session digest is verified or not by decrypting the session digest. This ScK comprises of a private key SK/ScK, and a public key, PK/ScK, this key set should not be confused with the ciphers used within the TLS procedure itself. They are distinct and are not related or operationally linked (means the ScK is only utilized to determine if each session digest is correct or not).

The object of the ScK is therefore designed to determine if the USSD gateway sending the session digest is an authorized USSD gateway to send such a request in the first place (prior to any TLS procedure to be implemented). If the cryptographic facility on the phone device does not find the digest verified, then it ignores the USSD gateway request and does nothing, as depicted at 20.

However, an unauthorized USSD gateway, if it is supplied with the MSISDN of a target user, can still, depending on how the USSD message is crafted, retrieve information about the target user phone device, such as its IMEI or device serial number. Provisions are further described later in this specification to address such a possibility.

Let us now assume that the session digest is decrypted and thus the identity of the USSD gateway verified between the cryptographic facility and the gateway/issuer, the cryptographic facility then begins to initiate the TLS “handshake” procedure.

Alternatively, the gateway may initiate the TLS procedure with the cryptographic facility on the user's phone device. This is depicted at 30, 40. Once the TLS is completed at 50, the cryptographic facility now maintains an encrypted USSD session or data communications link with the gateway. USSD messaging protocol is preferred due to two reasons; firstly, the user may be outside of the local coverage area of the user's telecommunication service provider, for instance, in a country outside the home country of the provider and attempting to make a transaction that relies on the multi-factor verification aspect of the present application—the USSD message is relayed from the provider's home SS#7 network to the roaming “foreign” operator's VLR/SS#7 domain, secondly, data exchange bandwidth expenses are incurred on the part of the operator, not the user directly (it appears free to the user as compared to a GPRS data link or SMS message for example).

The cryptographic facility then initiates within the user phone device a sub-routine to display an input prompt at 60 therefore requesting from the user to input the PIN code via the phone's keypad unit as depicted at 70, which is encrypted by the cryptographic facility using a Primary Key (PvK) Set.

The Primary Key (PvK) set is separate and distinct from the Secondary Key Set (ScK), and PvK is only utilized for a single function—the encryption of the PIN code entered on keypad by the user, as depicted at 80, and the encrypted PIN code is therefore transmitted using the encrypted USSD or data communications link to the gateway/issuer at 90.

Now referring to FIG. 15, PH1 is the phone device of a user, SEV1 is the computer device of the issuer. SEV1 may further comprise of a USSD gateway, or a USSD gateway switch and a number of gateways. The user phone PH1 stores within the cryptographic facility the private key part of the SECONDARY KEY ScK at 10 (hence the label SK/ScK), the public key part of the ScK is stored on SEV1 at 20.

Thus, SEV1 can only encrypt and send session digests to PH1, but not decrypt them, while PH1 can decrypt and therefore verify the session digests received from SEV1 as shown at 500. Also stored within cryptographic facility is the public key part of the PRIMARY KEY PvK, at 30, also labeled PK/PvK, thus, PH1 can only encrypt PIN code for transmittal, not decrypt the PIN code by itself as shown at 1000.

The private key part of PvK, is stored at 40 on SEV1.

Mobile phones are not known to be good computational devices that are adept at generating large cryptographically secure random numbers due to either constraint placed by the lack of memory, data storage, or appropriate standardized API access to any analog sensors that may be utilized as random vector value generators such as microphones, cameras, GPS voltage meters etc.

This places mobile phones at a disadvantage since cryptographically secure schemes would require large random numbers to begin with.

It should be noted that in the present application, the generation of the PvK set pair are implemented on the issuer's computational domain, NOT the phone device.

The PvK public key (PK/PvK) therefore may be generated at the issuer's said domain, and packaged within the cryptographic facility during download from the issuer to the user's phone device. This is suitably implemented during user enrollment with the issuer.

In another embodiment of the present application, both the PvK pair and the ScK pair are generated on the issuer's computational domain and packaged within the cryptographic facility for download from the issuer to the user—however, because the ScK packaged is the private key part of the ScK, it creates the undesirable out-of-band situation where the private key is transmitted from one domain to another.

Thus, disclosed therein is a method where the ScK key pair is generated for use by the phone device and issuer domain, by reference to FIG. 16.

PD1 shows the computational domain of the phone device of a user, wherein the IMSI (International Mobile Subscriber Identity) at 20 of the phone device PD1 is utilized for generation of two prime integer multiples p and q (p, q) at 90.

The IMSI can be polled and obtained from the USSD gateway application using the following:

MAP4MAP_DialoguePDU mapDialoguePDU =
(MAP4MAP_DialoguePDU)(event.getUserInformation( )[0]);
String imsi = mapDialoguePDU.getMap_open( ).getDestinationReference( ).getAddress( );

It should be noted that both IMSI of 20 and device serial number of 10 couldn't be utilized directly for generation of (p, q) and g as they are not, in a cryptographic sense, sufficiently random even they may be uniquely issued to a certain extent. However they do provide a vector source for subsequent use by the cryptographic facility to generate the (p, q) and g.

The IMSI 20 is first cryptographically hashed using a hash algorithm 40, which may be randomly selected by a random number generator “RNG/s” not shown and should not be confused with the random number generator depicted at 70.

The cryptographic facility stores a plurality of hash algorithm 40 such as SHA, FSB, MD5 etc, and one out of the said plurality of algorithms 40 are randomly selected by said RNG/s to generate a one-way hashed cipher block that is fed into random number generator at 70.

For example, if RNG/s selects SHA-1 to be the hashing algorithm and the device serial number of the phone is 6666 5555 4444 333, then the hash would be generated as:

87bfd2624a8 cc2950b298c333e0d5e563b73cd12

One non-limiting example of a FIPS-180 compliant hashing algorithm is described as follows in the programming language C (it should be noted that only the code for header file is shown, libraries are not shown):

#ifndef_SHA1_H_{—}
#define _SHA1_H_{—}
Class SHA1
{

public:

SHA1( );
virtual ~SHA1( );
/*
* Re-initialize the class
*/
void Reset( );
/*
* Returns the message digest
*/
bool Result(unsigned *message_digest_array);
/*
* Provide input to SHA1
*/
void Input( const unsigned char *message_array,

| | |
|---|---|
| unsigned | length); |

void Input( const char *message_array,

unsigned length);

void Input(unsigned char message_element);
void Input(char message_element);
SHA1& operator<<(const char *message_array);
SHA1& operator<<(const unsigned char *message_array);
SHA1& operator<<(const char message_element);
SHA1& operator<<(const unsigned char message_element);

private:

| /* | |
|---|---|
| * Process the next 512 bits of the message | |
| */ | |
| void ProcessMessageBlock( ); | |
| /* | |
| * Pads the current message block to 512 bits | |
| */ | |
| void PadMessage( ); | |
| /* | |
| * Performs a circular left shift operation | |
| */ | |
| inline unsigned CircularShift(int bits, unsigned word); | |
| unsigned H[5]; | // Message digest buffers |

| unsigned Length_Low; | // Message length in bits |
|---|---|
| unsigned Length_High; | // Message length in bits |
| unsigned char Message_Block[64]; // 512-bit message | |
| blocks | |
| int Message_Block_Index; | // Index into message block array |

| | |
|---|---|
| bool Computed; | // Is the digest computed? |
| bool Corrupted; | // Is the message digest corrupted? |

};
#endif

The random number generator 70 makes use of the hashed value, and the seed integer of 50, to generate the prime integers p and q.

In one non-limiting example, the generation of p and q from the hashed IMSI may be implemented as follows:

Let L−1=n*160+b, where b, n are integers 0≦b<160,
a. SEED=[SD1 (seed integer 50)+f(L−1=n*160+b)]+[IMSI(SHA-0a)+f(convert IMSI(SHA-0a) into prime integer) where 2^{L-1}<p<2^{L} for 512≦L≦1024 and L is a multiple of 64],
b. U=SHA-1[SEED] XOR SHA-1[(SEED+1) mod 2^{g}]

Wherein q is derived from U, q=U OR 2¹⁵⁹ OR 1 and 2¹⁵⁹<q<2¹⁶⁰

K=0, . . . , n whereas
c. Vₖ=SHA-1[(SEED+offset+k) mod 2^{g}]
d. W=V₀+V₁*2¹⁶⁰+ . . . +Vⁿ⁻¹*2^{(n-1)*160}+(Vₙ mod 2^{b)*}2ⁿ*¹⁶⁰
e. X=W+2^{L-1} where 0≦W<2^{L-1}
f. c=X mod 2q, p=X−(c−1)

In one embodiment, the seed integer 50 is a keypad input prompt request given by the cryptographic facility for the user to perform input of the seed integer 50, and seed integer 50 is provided by the issuer to the user during enrollment as a one-time exercise—thus, integer 50 is generated by the issuer.

The random number generator of 70 thus makes use of 50 and the hashed value from 40 to generate a composite integer string, which is then applied to a numerical function device 80 to generate the prime integer multiple of p and q.

The prime integer multiples (p, q) are utilized in a non-limiting, partial example of 500a to generate the private key part of ScK, the SK/ScK.

The device serial number 10, which in the case of a GSM phone device would be the IMEI, and in the case of a CDMA or UMTS phone device, would be either a ESN or MEID, is cryptographically hashed into a hashed cipher at 30, and fed into the random number generator of 70 with a seed integer of 60, to yield a composite integer string, which is then applied to a numerical function device of 80 to generate the security parameter integer g as shown at 100.

In one non-limiting example, the generation of g from the hashed IMEI (or device serial number) may be implemented as follows:
a. e=(p−1)/q
b. h=[SD2 (seed integer 60)+f(L−1=n*160+b)]+[IMEI(SHA-0b)+f(convert IMEI(SHA-0b) into prime integer) where 2^{L-1}<p<2^{L} for 512≦L≦1024 and L is a multiple of 64], and 1<h<p−1 and where h≠p, h≠q, h≠SD1, h≠SD2.
c. g=h^{e} mod p

Seed integers 60 and 50 are generated by the computer device of the issuer using cryptographically secure random number generators, and are then utilized by the random number generator residing within the cryptographic facility of the phone device PD1, using hashed values of the IMSI and device serial numbers to subsequently derive the integers of (p, q, g).

The security parameter integer g is, in a non-limiting partial example of 500b, utilized to generate the public key part ScK, the PK/ScK, in yet another preferred embodiment of the present application, the security parameter integer g is critical security parameter utilized by the cryptographic facility of phone device PD1.

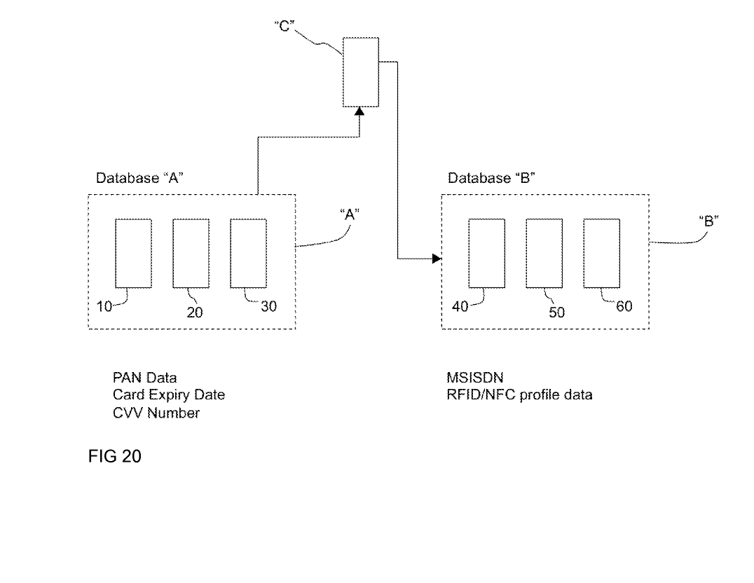

With reference to FIG. 20, a feature of the present application is disclosed wherein a debit-credit card network stores cardholder related data in a primary and secondary database.

Database “A” is operable to store a set of data related to a cardholder such as the cardholder's PAN (primary account number), which in some cases, is the credit-debit card number itself, and accompany information such as card name, CVV security code and card expiry date may be in the same database record.

While there are already regulations in place such as Visa's Cardholder Information Security Program (CISP), MasterCard's Site Data Protection (SDP), American Express' Data Security Operating Policies (DSOP) and Discover's Information Security and Compliance (DISC) regulations, and recently, a standardized Payment Card Industry Data Security Standard (PCI DSS), they are expected to have incremental impact over the medium term since no merchant security architecture is uniform and individual systemic vulnerabilities vary from one merchant or card processor to another.

A multi-factor authentication model for transactions such as debit-credit card transactions provides diversification of verification tiers over more than one data band, thus another set of data, called user verifying record or data is stored instead on a secondary database. In an ideal computational environment, the primary and secondary databases are isolated relative to access rights and privileges.

A common but often overlooked data storage policy is the clustering of data-sets into a single table or a related group within a computational space having higher access rights than necessary, for example, database storing cardholder records residing on a secure server within the same domain group as the administrator server.

Various vulnerabilities involving databases such as DB 2, Oracle 11g, etc have been taken advantage of due to the potential attack vector above.

Further, in some operational scenarios, having isolated database islands provide payment processor-issuer business models.

Data items 10, 20 and 30 stored in a record belonging to a identified cardholder on database “A” may encompass the PAN, and said accompanying information, and said PAN, or a portion of said PAN is utilized in a function routine “C” to derive a record number to which it is stored and indexed on database “B”, operationally linked to a related record on database “B” containing additional data that is utilized for verification of cardholder during multi-factor transactions.

Such additional data comprises a MSISDN or calling number of the cardholder's elected phone device, and or any other data that is related to such cardholder, as labeled at 40, 50 and 60.

In one embodiment, this data storage medium instruction can be adapted to store the cardholder's PAN on database “A” while multi-factor verification data such as MSISDN, RFID (radio frequency identification), NFC (near field communications) are stored on database “B”. The database record stored on “B” does not contain information that reveals or provides indirect disclosure to the cardholder, thus in such manner wherein PAN, expiry date, address or name are omitted and the verifying record may be indexed by a algorithmically derived record ID data instead.

Persons skilled in the art will be able to understand that the algorithmic function can be optimized for high I/O data-stream operations “on-the-fly” to match the transient I/O bandwidth required between database “A” and “B”, for instance, the algorithmic function can be developed as a distributed application in a server farm that resides between I/O path of database “A” and “B”.

Alternatively, merchant transaction processing is performed several layers downstream on the side of database “A” while issuer-cardholder transaction verification is validated downstream on the side of database “B”.

In another embodiment of the above feature of this application, a session activation code (SA) is deployed to provide additional rights management at a granular level on database “B”, since prior to initialization of cardholder verification the transaction request message would have been at least partially processed downstream of database “A”, for example—this ensures that routine code block logically linking the PAN record on database “A” to the verifying record on database “B” is dynamically generated for EACH transaction request message received.

This “transaction processor” model is useful in scenarios where the issuer has separate datacenters that are logically partitioned to a single computational application space.

Further embodiments of the application are provided in the following itemized list, wherein the various items can also be combined with each other.
1) Item 1: A transaction-processing system for performing multi-factor verification of transactions between a plurality of users and a verification processor, said processor in operational communication with a database storing a plurality of verification records, wherein each record comprising an unique ID and said record containing at least one unique user value, such as an MSISDN value, and each record comprising at least one reference device serial number value, and each verification record logically and/or uniquely associated with each of the said plurality of users, the system comprising:
   a routine for reading from a first memory space a verification request message and routine associating said request message to an associated verification record stored on database,
   verification processor initiating a remote wireless communications link to a phone device associated with said verification record MSISDN value and sending a user input request message to said phone device,
   verification processor sending at least one command routine during the said communications link to poll from said phone device a retrieved device serial number value,
   verification processor receiving from phone device during remote wireless communications link a user response message in response to the said user input request message,
   the transaction-processing system reading from verification processor said retrieved device serial number value and performing a function call to match retrieved device serial number value against the reference device serial number value to generate a function call result value,
   the transaction-processing system generating a verification response message using said function call result value and said received user response message, the said system further writing the generated verification response message to said first memory space,
   transaction-processing system performing and completing multi-factor verification of at least one transaction associated with the verification request message based in part on the generated verification response message.
2) Item 2: A transaction-processing system for performing multi-factor verification of transactions between a plurality of users and a verification processor, said processor in operational communication with a database storing a plurality of verification records, wherein each record comprising an unique ID and said record containing at least one MSISDN value, and each record comprising at least one reference device serial number value, and each verification record logically and uniquely associated with each of the said plurality of users, the system comprising:
   (a) routine for reading from a first memory space a verification request message containing a push flag (PSH) and PSH is set and said system associating said request message to a verification record stored on database,
   (b) verification processor initiating a remote wireless communications link to a phone device associated with said verification record MSISDN value and sending a user input request message to said phone device,
   (c) verification processor sending a command routine during the said communications link to poll from said phone device a retrieved device serial number value,
   (d) verification processor receiving from phone device during said communications link a user response message in response to the said user input request message, the verification processor generating a first input flag (INT1) if the received response message contains a first text identifier code, verification processor generating a second input flag (INT2) if said processor receives from said phone device said user response message containing a second text identifier code instead,
   (e) the transaction-processing system reading from verification processor said retrieved device serial number value and performing a function call to match retrieved device serial number value against the reference device serial number value to generate either a match-pass flag (MTP) or a match-fail flag (MTF), wherein MTP is indicative of a match and MTF is indicative of a mismatch between said retrieved device serial number value and said reference device serial number value,
   (f) verification processor generating a verification response message in the said first memory space using the generated flags from step (d) and step (e).
3) Item 3: The transaction-processing system of item 1 and/or 2 wherein reference device serial number value is a IMEI (international mobile equipment identity), or a MEID (Mobile Equipment Identifier), or a ESN (electronic serial number), or a IMSI (International Mobile Subscriber Identity).
4) Item 4: The transaction-processing system of one of items 1 to 3 wherein remote wireless communications link is a network initiated USSD (unstructured supplementary service data) messaging service.
5) Item 5: The transaction-processing system of one of items 1 to 4 wherein first memory space is in operative communication with at least one network domain selected from the group comprising of an ATM (automated teller machine) host network, a debit or credit card processing network, a POS (point-of-sale) terminal host network, an electronic banking application host network, a currency remittance application host network.
6) Item 6: The transaction-processing system of one of items 1 to 5 wherein said user input request message contains a plurality of unique transaction options each said option tagged with a unique text identifier code and a chosen transaction option is indicated in the said user response message by user input of the chosen said identifier code indicative of said chosen transaction option and transmittal of chosen text identifier code from said phone device to verification processor.
7) Item 7: The transaction-processing system of one of items 1 to 6 wherein said user input request message contains an input prompt for the user's PIN code, or user's CVV2, or the user's CVC2, or the user's card security code to be entered and transmitted from said phone device to verification processor.
8) Item 8: A multi-factor verification system for conducting a automated teller machine (ATM) transaction between a cardholder, a ATM host network and card issuer, the method comprising the steps:
   (a) cardholder performing enrollment with card issuer including input and data submission to card issuer a MSISDN value associated with a cardholder elected phone device calling number, (b) card issuer storing said MSISDN value to an operationally connected database, (c) card issuer electronically associating the MSISDN value of step (b) with said cardholder stored account information using at least one code routine,
   (d) cardholder presenting to an ATM unit in operational communication with said ATM host network a card apparatus provided by the card issuer, (e) cardholder performing input of cardholder's PIN code to ATM unit, (f) ATM unit generating an authorization request message to said host network based in part on data residing in card apparatus and said input PIN code, (g) ATM host network routing authorization request message to the card issuer, (h) card issuer receiving said authorization request message, and retrieving said cardholder stored account information, (i) card issuer retrieving MSISDN value of step (c) and said issuer initializing a network-initiated USSD (unstructured supplementary service data) messaging session between issuer and said phone device of step (a) based in part on said retrieved MSISDN,
   (j) card issuer providing a user input request message to the cardholder during the messaging session of step (i) and said message comprising a transaction confirmation answer, a transaction cancellation answer, and a cardholder alert answer, (k) card issuer receiving a user response message from said phone device containing a transaction confirmation answer, or a transaction cancellation answer, or a cardholder alert answer from step (j) elected and input by the cardholder and issuer generating a transaction authorization message based in part from received answer from user response message from step (k) and said cardholder stored account information, (l) card issuer forwarding the generated transaction authorization message to the ATM host network and said host network routing data instruction indicative of said authorization message to ATM unit, (m) said ATM unit executing and completing the transaction based in part on the received data instruction of step (l).
9) Item 9: The multi-factor verification system of claim 8, wherein card issuer will electronically instruct ATM host network, ATM unit to withhold card apparatus in ATM unit, card issuer will electronically invalidate code routine operational association with stored cardholder information if user response message received from cardholder contains said cardholder alert answer of step (k), or a combination thereof.
10) Item 10: A multi-factor verification process for performing automated teller machine (ATM) transactions comprising;
   (a) an issuance routine for issuing a card apparatus containing cardholder data to a cardholder and said apparatus having a default offset PIN code wherein cardholder data is operationally associated with cardholder account information,
   (b) an enrollment routine for enrollment of the cardholder's MSISDN indicative of cardholder mobile phone calling number and operationally associating said cardholder MSISDN with the cardholder's private PIN code, cardholder account information, or a combination thereof,
   (c) a transaction routine for receiving from a ATM host network a transaction request related to said cardholder,
   (d) transaction routine for establishing an encrypted remote communications link to said cardholder's mobile phone device bearing the said MSISDN and requesting from cardholder input of said private PIN code,
   (e) transaction routine for receiving said private PIN code digest from step (d) and generating an authorization message based in part, on private PIN code digest received and cardholder account information, for transmittal to the ATM host network, ATM host network operable to execute and complete the transaction request in response to received authorization message.
11) Item 11: The multi-factor verification system of item 10 wherein cardholder performs input of default offset PIN code via an ATM device in operational communication with the ATM host network.
12) Item 12: A secure system for ATM (automated teller machine) transactions between a plurality of users and a ATM host network comprising:
   ATM host network in operative communication with a plurality of ATM devices and receiving a transaction request signal from at least one ATM device said request signal containing data indicative of the transaction originating user and information indicative of a first PIN code input from transaction originating user,
   ATM host network associating transaction request signal to said transaction originating user account record data and ATM host network initializing a secure electronic communications data exchange data-stream between said user and said network, using a stored reference user MSISDN signal operationally associated with transaction originating user account record data wherein MSISDN signal is indicative of the portable phone calling number of transaction originating user,
   ATM host network requesting from said user the input of a second PIN code and said network receiving during said data-stream a response signal comprising and indicative of said second PIN code from transaction originating user,
   ATM host network using transaction request signal and said received response signal to verify against user account record data to generate a transaction authorization response signal,
   ATM host network transmitting said transaction authorization response signal to said ATM device wherein said device executes said transaction in response to said authorization response signal received.
13) Item 13: A multi-factor verification method between a user phone device and a remote verification processor wherein user phone device contains a cryptographic facility to generate PIN code digest indicative of a PIN code supplied via keypad input on the said device and transmittal of the said PIN code digest to the verification processor using an encrypted communications link established between said phone and verification processor comprising;
   cryptographic facility receiving from an initial communications link session initiated by verification processor a session digest and cryptographic facility using a SK private key part (SK/ScK) of a secondary key pair (ScK) to verify the session digest, cryptographic facility configured to establish an encrypted communications link between the phone device and verification processor if the session digest is correctly verified by SK/ScK,
   cryptographic facility providing a secure keypad prompt for input of a PIN code on the said phone device, and cryptographic facility generating a PIN code digest indicative of the PIN code using a PK public key part (PK/PvK) of a primary key pair (PvK), cryptographic facility sending the PIN code digest to the verification processor using the encrypted communications link.
14) Item 14: The multi-factor verification method of item 13 wherein the verification processor generates the session digest using a PK public key part of the secondary key pair (PK/ScK), both the PK/ScK and SK/ScK parts of the secondary key pair (ScK) initially generated on said cardholder phone device by the cryptographic facility comprising,
   generating the SK/ScK using a SK cryptographic algorithm and the set of two prime integer multiples (p, q) wherein,
   cryptographic facility obtaining a IMSI (international mobile subscriber identifier) and using IMIS with a first cryptographic hash to generate a IMSI digest, then using IMSI digest with a random number generator and first seed value (SD1) to derive said prime integer multiples p and q,
   generating the PK/ScK using a PK cryptographic algorithm and the set of integers (n, g) wherein n is the numerical output of p and q and g is a security parameter value, and
   cryptographic facility obtaining a device serial number and using device serial number with a second cryptographic hash to generate a device digest, then using device digest with a random number generator and second seed value (SD2) to derive the security parameter value g, said security parameter g derived calculated with PK cryptographic algorithm during said generation of PK/ScK to make PK/ScK key semantically secure,
   cryptographic facility operable to transmit only PK/ScK from phone device to the verification processor for subsequent generation of the said session digest by the verification processor, and said facility storing SK/ScK within cryptographic facility memory space for subsequent verification of the session digest received from verification processor.
15) Item 15: The multi-factor verification method of item 13 and/or item 14, wherein the primary key pair (PvK) comprising a PK public key part (PK/PvK) of said PvK and a SK private key part (SK/PvK) of said PvK, where PvK is generated on verification processor and only PK/PvK is contained within the cryptographic facility residing on phone device, and the secondary key pair (ScK) comprising a PK public key part (PK/ScK) of said ScK and a SK private key part (SK/ScK) of said ScK, where ScK is generated on the phone device using cryptographic facility and only the PK/ScK is transmitted to the verification processor and SK/ScK is contained within the cryptographic facility on the phone device.
16) Item 16: The multi-factor verification method of one of items 13 to 15 wherein said initial communication link session is a network-initiated USSD (unstructured supplementary service data) messaging service.
17) Item 17: The multi-factor verification method of one of items 13 to 16 wherein cryptographic facility operable to prompt cardholder to perform input of a random alphanumeric code to derive first seed value SD1 and second seed value SD2, and said alphanumeric code initially generated by verification processor and displayed to cardholder using a data channel not belonging to initial communication link session and encrypted communications link.
18) Item 18: A cryptographic system comprising:
   identifying a session digest message to be sent to a target device in response to a session request initiated by a remote main processor belonging to the said system; selecting a specific one-time generated session digest to be inserted in the session digest message, wherein the target device is the intended recipient of the specific one-time generated session digest and said digest is generated using a current public encryption key (PK/ScK/a); forwarding the session digest message to the target device;
   target device receiving the said session digest message, said device using a cryptographic sub-processor and a current private decryption key (SK/ScK1) to verify the contained one-time generated session digest; sub-processor initiating and exchanging transport layer security (TLS) cryptographic protocol data with the main processor to establish a encrypted data communication link between sub-processor and main processor if said session digest is verified;
   sub-processor ignoring the main processor if said session digest is not verified.
19) Item 19: The cryptographic system of item 18 wherein both current public encryption key PK/ScK/a and current private decryption key SK/ScK1 are not operationally associated with said TLS (transport layer security cryptographic protocol) pre master secret key, or TLS cipher suite or TLS session key.
20) Item 20: The cryptographic system of item 18 and/or item 19, wherein main processor is operable to transmit to sub-processor a new private decryption key SK/ScK2 to replace the current private decryption key SK/ScK1 during the encrypted data communication link.
21) Item 21: The cryptographic system of one of items 18 to 20 wherein sub-processor of target device will perform verification of a subsequent session digest message received from the main processor using the new private decryption key SK/ScK2 and the main processor using public encryption key PK/ScK/b operationally associated with SK/ScK2 to generate the session digest of the said subsequent session digest message.
22) Item 22: A multi-factor transaction-processing system for performing verification of transactions between a plurality of users and a verification processor wherein part of the said verification of each transaction is implemented between a gateway device and a phone device belonging to a specific user of each originating transaction of said plurality of users, the verification processor further comprising at least one gateway switch and a plurality of gateway devices are in operative communication with the gateway switch,
   verification processor in operative communication with a database and said processor receiving a plurality of transaction verification request signals, verification processor operable to read from each said verification request signal a primary account number belonging to a specific user, and retrieving using primary account number from said database a MSISDN value and a reference device serial number belonging to said specific user,
   and verification processor routing the said MSISDN value to the gateway switch wherein the gateway switch will determine and a routine to generate and allocate each MSISDN request signal comprising said MSISDN value to a specific gateway device that is available and ready to execute each said transaction verification request signals, allocating routine comprising,
   gateway switch interfacing with said plurality of gateways using network-initiated USSD messaging protocols for sending network-initiated messages addressed to a designated user MSISDN and for receiving said user MSISDN mobile originated messages addressed to said gateway device,
   and allocating routine also comprising a routing configuration for routing said network-initiated messages from verification processor to the correct gateway device and for routing MSISDN mobile originating messages from gateway device to the correct verification processor specified said primary account number,
   verification processor further comprising a fault routine for reading gateway device fault data and gateway device message traffic throttle rate to include into said routing configuration to select the least busy gateway device to perform and process transaction verification request signal, and verification processor including in said network-initiated message addressed to said designated user MSISDN at least one command routine operable to retrieve from user device bearing said MSISDN the said device serial number.
23) Item 23: The multi-factor transaction-processing system of item 22 wherein the verification processor receives from gateway switch a specific user MSISDN mobile originated message containing the retrieved device serial number and performing a function call to match said serial number against the reference device serial number and said processor generating a first control signal if is there is a match or generating a second control signal if there is no match, said verification processor operable to generate a verification result signal based in part on said specific user MSISDN mobile originated message, said first or second control signal, or a combination thereof, verification result signal indicative of the outcome of verification of said user in association with said transaction operationally associated with said transaction verification request signal received.
24) Item 24: A debit-credit card transaction-processing system for implementing multi-factor cardholder verification using a verification processor to perform cardholder verification and said processor operable to provide a verification result data (VERD) numeric value for the transaction-processing system to generate a ISO 8583 authorization response (ARQ) message for transmittal to a transaction originating network based in part on said VERD numeric value and cardholder account data (CAD) operationally associated with a determined cardholder, comprising:
   said system receiving a ISO 8583 authorization request (ARS) and reading from ARS the primary account number (PAN) of the cardholder for retrieval of a MSISDN associated with said PAN from a database in operative communication with said processor, said processor operable to read from ARS the transaction amount and then generating a user input request message said message using a network-initiated USSD (unstructured supplementary service data) messaging service protocol containing the said transaction amount and a plurality of unique cardholder response options,
   verification processor establishing a network-initiated USSD (unstructured supplementary service data) messaging service and sending said user input request message to the cardholder elected phone device bearing said retrieved MSISDN, the verification processor receiving during said USSD service a cardholder input elected response option data in response to user input request message, and verification processor generating a VERD numeric value corresponding to indicative intent of said cardholder input elected response option data,
   verification processor providing said system with VERD numeric value, the transaction-processing system operable to generate first ARQ message to the transaction originating network based in part on said CAD indicative of an approved transaction code and said VERD numeric value is indicative of a successful verification implemented between verification processor and said cardholder elected phone device,
   said system operable to generate second ARQ message to be indicative of a transaction declined or failed if said VERD numeric value is indicative of an unsuccessful verification implemented between verification processor and said cardholder elected phone device, and transmit the second ARQ message to the transaction originating network, regardless said CAD being indicative of an approved transaction code.
25) Item 25: The transaction-processing system of item 24 wherein a successful verification between the verification processor and said cardholder elected phone device is the result of the cardholder electing said response option data indicative of the cardholder's intention to confirm the transaction during said established USSD service.
26) Item 26: The transaction-processing system of item 24 and/or 25 wherein a successful verification between the verification processor and said cardholder elected phone device is the result of the cardholder electing said response option data indicative of the cardholder's intention to confirm the transaction during said established USSD service, and, said system finding a match between a device serial number obtained from cardholder elected phone device during said USSD service and a reference cardholder device serial number stored in said database.
27) Item 27: The transaction-processing system of one of items 24 to 26 wherein a successful verification between the verification processor and said cardholder elected phone device is the result of the cardholder electing said response option data inclusive of cardholder keypad input of a card security code, or CVV2 code, or CVC2 code indicative of the cardholder's intention to confirm the transaction during said established USSD service and said system finding a match between the said keypad input code and a reference cardholder keypad input code stored in verification processor, database, transaction processing system, or a combination thereof.
28) Item 28: A method for performing debit-credit card multi-factor user verification comprising storing at least one debit-credit card user data on a primary database and storing debit-credit card user verifying record on a secondary database wherein debit-credit card user data on the primary database comprising at least a primary account number (PAN) is derived and utilized in at least one algorithmic function to yield and generate a record ID to be stored and operationally associated with debit-credit card user verifying record on the said secondary database, debit-credit card user verifying record comprising at least the user MSISDN, said secondary database in operative communication with a USSD (unstructured supplementary service data) gateway operable to establish and set up a network-initiated USSD messaging service session using the MSISDN given and a session activation (SA) code received from a SA code originating device for each received pending transaction request that is operationally associated with debit-credit card user data on primary database, comprising;
   said algorithmic function generating said record ID in one or more determined mathematical arrangement wherein debit-credit card user verifying record stored on secondary database cannot be operationally associated with debit-credit card user data on a primary database without algorithmic function, SA code, or a combination thereof;
   said SA code originating device operable to provide one or more formatted USSD message intended for said given MSISDN to USSD gateway.
29) Item 29: A system for performing multi-factor transaction verification between one or more user from a transaction originating network and a issuer-network, where each user attempts a transaction with the transaction originating network using first verification part comprising input of user card account data and or user access authentication data and a transaction request transmitted from said originating network to the issuer-network,
   issuer-network comprising routine code function for reading from transaction request determined data therein for retrieving from a database in operational communication with issuer-network said user MSISDN and said user account information, and
   interface function for interfacing with a plurality of external messaging gateways (EMG) using network-initiated USSD messaging protocols for sending one or more network-initiated message addressed to user MSISDN and for receiving said user MSISDN mobile originated messages addressed to said EMG,
   wherein said interface function comprising a routing configuration for routing said network-initiated messages from issuer-network to the correct EMG and for routing MSISDN mobile originating messages from EMG to the correct issuer-network user account information,
   and issuer-network comprising traffic routine code for reading EMG fault data and EMG message traffic throttle rate to include into said routing configuration to select the least busy EMG to perform user second verification part, the second verification part comprising:
   (a) issuer-network providing in a network-initiated message addressed to user MSISDN a determined number of user input request message options, and receiving from EMG user MSISDN mobile originated message indicative of an elected input option by said user and containing a retrieved designated user mobile device serial number, or
   (b) issuer-network providing in a network-initiated message addressed to user MSISDN a keypad input request from said user for a card security code, and receiving from EMG user MSISDN mobile originated message indicative of a card security code, or CVV2 code or CVC2 code input provided by said user and containing a retrieved designated user mobile device serial number,
   issuer-network using first and second verification parts against said user account information to derive and generate a transaction authorization,
   issuer-network transmitting transaction authorization of either step (a) or step (b) to the said transaction originating network.
30) Item 30: A system for performing multi-factor ATM (automated teller machine) transaction verification between one or more user from a transaction originating network and a issuer-network, where said user attempts a ATM transaction with the transaction originating network using first verification part comprising a ATM card apparatus and input of a PIN code with a ATM unit in operational communication with the transaction originating network and a transaction request transmitted from transaction originating network to the issuer-network,
   issuer-network comprising a routine code function for reading from transaction request determined data therein for retrieving from a database user's MSISDN and user's account information, and
   interface function for interfacing with a plurality of external messaging gateways (EMG) using network-initiated USSD messaging protocols for sending one or more network-initiated message addressed to said user MSISDN and for receiving said user MSISDN mobile originated messages addressed to said EMG,
   wherein said interfacing comprising a routing configuration for routing said network-initiated messages from issuer-network to the correct EMG and for routing MSISDN mobile originating messages from EMG to the correct issuer-network user account information,
   and issuer-network comprising traffic routine code for reading EMG fault data and EMG message traffic throttle rate to include into said routing configuration to select the least busy EMG to perform user second verification part, the second verification part comprising:
   (a) issuer-network providing in a network-initiated message addressed to user MSISDN a determined number of user input request options, and receiving from EMG user MSISDN mobile originated message indicative of an elected input option by said user and containing a retrieved user mobile device serial number, or
   (b) issuer-network providing in a network-initiated message addressed to user MSISDN a keypad input request from said user for a PIN code, and receiving from EMG user MSISDN mobile originated message indicative of a PIN code provided by said user,
   issuer-network using first and second verification parts against said user account information to derive and generate a transaction authorization, issuer-network transmitting transaction authorization to the said transaction originating network.
31) Item 31: A secure system for credit or debit card transactions between a cardholder and the card issuer, comprising:
   issuer operationally associating an elected MSISDN to the cardholder,
   issuer receiving a transaction request from a transaction originating network and deriving from said request information related to the cardholder,
   issuer sending a message designated to the cardholder elected MSISDN using network-initiated USSD messaging protocol,
   issuer requesting from cardholder input of a card security code, or CVV2 code, or CVC2 code and said cardholder sending said input in a message designated to issuer using network-initiated USSD messaging protocol,
   issuer verifying the received said card security code, or CVV2 code, or CVC2 code against said cardholder information,
   issuer computing and generating a transaction response signal and sending the said response signal to the transaction originating network.
32) Item 32: A system of all the preceding claims wherein MSISDN is either the MSISDN (mobile subscriber ISDN number) or MIN (mobile identification number) or call number in a telecommunications network associated with the user or cardholder.
33) Item 33: A multifactor verification system for inserting a mobile user input request into a USSD message, the system comprising:
   identifying a USSD message to be sent by a gateway to a mobile user of a mobile device in response to a verification request initiated by the system;
   selecting a specific mobile user transaction amount to be inserted in the USSD message, wherein the mobile user is a target and intended recipient of the specific user transaction amount;
   generating one or more user transaction choice to be inserted in the USSD message, each said choice transcoded with an unique identifying code;
   formatting said mobile user transaction amount and said choice transcoded with said identifying code to adapt to a character set of the USSD message;
   forwarding said USSD message to the mobile user;
   monitoring the mobile user's response to the USSD message forwarded, wherein the mobile user's response is sent through the mobile device;
   routing the mobile user's response from gateway to the said system.
34) Item 34: The system of item 33 wherein user transaction amount selected by system is associated with a transaction request message received from a transaction originating network that is hosting said transaction originated by the mobile user.
35) Item 35: The system of item 33 and/or 34, wherein one or more user transaction choice remains proximately consistent for each USSD message forwarded to mobile user for each mobile user originated transaction.
36) Item 36: The system of one of items 33 to 35 wherein one or more user transaction choice is transcoded with a one-time unique identifying code for each USSD message forwarded to mobile user for each mobile user originated transaction and said mobile user inputs an elected one-time unique identifying code that corresponds to a mobile user elected transaction choice for transmittal to said system.
37) Item 37: The system of one of items 33 to 36 wherein transaction originating network is selected from an ATM (automated teller machine) host network, a POS (point-of-sale) terminal host network, a credit card host network, a debit card host network, an electronic banking application host network, a currency remittance application host network, or a combination thereof.
38) Item 38: A multifactor authentication system for inserting a mobile user logon confirmation request into a USSD message, the system comprising:
   identifying a USSD message to be sent by a gateway to a mobile user of a mobile device in response to a verification request initiated by the system;
   selecting a specific mobile user nickname to be inserted in the USSD message, wherein the mobile user is a target and intended recipient of the specific nickname and said nickname indicative of the said user's computer network logon ID (user identifier, “UID”);
   generating one or more mobile user logon confirmation choice to be inserted in the USSD message, each said choice transcoded with an unique identifying code;
   formatting said mobile user nickname and said choice transcoded with said identifying code to adapt to a character set of the USSD message;
   forwarding said USSD message to the mobile user;
   monitoring the mobile user's response to the USSD message forwarded, wherein the mobile user's response is sent through the mobile device;
   routing the mobile user's response from gateway to the said system.
39) Item 39: The system of item 38 wherein mobile user nickname selected by system is associated with a mobile user logon confirmation request received from a computer network that is hosting the logon attempt originated by the mobile user, said user attempting to logon to the computer network using a computer client device and USSD message is forwarded to the user's mobile device.
40) Item 40: The system of item 38 and/or 39, wherein one or more mobile user logon confirmation choice remains proximately consistent for each USSD message forwarded to mobile user for each mobile user originated logon attempt.
41) Item 41: The system of one of items 38 to 40 wherein one or more mobile user logon confirmation choice is transcoded with a one-time unique identifying code for each USSD message forwarded to mobile user for each mobile user originated logon attempt and said mobile user inputs an elected one-time unique identifying code that corresponds to a mobile user elected logon confirmation choice for transmittal to said system.
42) Item 42: The system of one of items 38 to 41 wherein mobile user inputs mobile user logon ID and at least one logon password data during the logon attempt with the computer network, and said computer network granting mobile user computer network access against the received said logon ID, said password data and said mobile user elected logon confirmation request response.
43) Item 43: A computer storage medium having instructions encoded thereon for determining whether a mobile telephone number provided in association with a financial transaction is a valid transaction token or a non-valid transaction token, and for evaluating, based at least in part on the determination, the validity of the financial transaction, the computer storage medium comprising:
   a computer encoded instruction for receiving input indicative of a mobile telephone number for an entity participating in a financial transaction;
   a computer encoded instruction for initiating and delivering a network-initiated, USSD messaging session intended and addressed to the mobile telephone number;
   a computer encoded instruction for obtaining a device serial number during said USSD messaging session;
   a computer encoded instruction for determining whether the obtained device serial number indicates that the mobile telephone number is a valid transaction token or a non-valid transaction token;
   a computer encoded instruction for evaluating the validity of the financial transaction, based at least in part on the determination;
   a computer encoded instruction for storing a retrievable record comprising at least one of: the mobile telephone number, the reference device serial number; and
   a computer encoded instruction for accessing the retrievable record in association with a subsequent financial transaction in order to use information in the record to evaluate the validity of the subsequent financial transaction token.
44) Item 44: The computer storage medium of item 43, wherein the computer encoded instruction for evaluating transaction token validity comprises a computer-encoded instruction for comparing and matching the obtained device serial number against the reference device serial number, and said transaction token evaluated as valid if there is a match or transaction token evaluated as non-valid if there is no match.
45) Item 45: A computer storage medium having instructions encoded thereon for determining whether a mobile telephone number provided in association with a user transaction is a valid transaction token or a non-valid transaction token, and for evaluating, based at least in part on the determination, the validity of the user transaction, the computer storage medium comprising:
   a computer encoded instruction for receiving input indicative of a mobile telephone number for an entity participating in a user transaction; a computer encoded instruction for storing a retrievable record comprising at least one of: the mobile telephone number, the reference device serial number;
   a computer encoded instruction for initiating and delivering a network-initiated, USSD messaging session intended and addressed to the mobile telephone number; a computer encoded instruction for obtaining a device serial number during said USSD messaging session;
   a computer encoded instruction for determining whether the obtained device serial number indicates that the mobile telephone number is a valid transaction token or a non-valid transaction token, said computer encoded instruction for evaluating transaction token validity comprises a computer-encoded instruction for comparing and matching the obtained device serial number against the reference device serial number, and said transaction token evaluated as valid if there is a match or transaction token evaluated as non-valid if there is no match;
   a computer encoded instruction for sending a one-time generated code for use with the user transaction wherein said one-time generated code is delivered using the said USSD messaging session;
   a computer encoded instruction for evaluating the validity of the user transaction, based at least in part on the determination and the one-time generated code delivered; and
   a computer encoded instruction for accessing the retrievable record in association with a subsequent user transaction in order to use information in the record to evaluate the validity of the subsequent user transaction token.
46) Item 46: A computer storage medium having instructions encoded thereon for facilitating debit-credit card multi-factor user verification comprising storing at least one debit-credit card user data on a primary database and storing debit-credit card user verifying record on a secondary database wherein debit-credit card user data on the primary database comprising at least a primary account number (PAN) is derived and utilized in at least one algorithmic function to yield and generate a record ID to be stored and operationally associated with debit-credit card user verifying record on the said secondary database, comprising;
   said algorithmic function generating said record ID in one or more determined mathematical arrangement wherein debit-credit card user verifying record stored on secondary database cannot be operationally associated with debit-credit card user data on a primary database without algorithmic function, an machine-to-machine (MTM) authentication code, or a combination thereof; and
   debit-credit card user verifying record comprising a digital signature, a digital certificate, a biometric profile data signal, a radio frequency (RF) profile data signal, a smart card profile data signal, a user ID, a user password, a user passphrase, or combinations thereof.
47) Item 47: The computer storage medium of item 46 wherein machine-to-machine (MTM) authentication code is generated and transmitted to algorithmic function at each instance where a debit-credit card transaction request message is received.
48) Item 48: A multi-factor cardholder verification system for automated teller machine (ATM) transactions, comprising;
   ATM for receiving cardholder data and PIN code from ATM data input apparatus;
   ATM for generating a request signal based on cardholder data and PIN code and transmitting request signal from ATM to a remote processor;
   remote processor in operational communication with at least one database;
   remote processor for receiving request signal and retrieving from database a verification record based in part on request signal received;
   remote processor for preparing and transmitting at least one target message signal intended for a cardholder in response to request signal, verification record retrieved, or a combination thereof;
   remote processor monitoring and waiting from cardholder for a return signal in response to transmitted target message signal;
   remote processor receiving from cardholder a return signal and remote processor for generating a command signal based in part on received return signal, verification record, cardholder data and PIN code, or a combination thereof;
   remote processor transmitting command signal to ATM, and ATM processing and providing access for performing transactions between ATM and said cardholder in response to command signal received.
49) Item 49: The multi-factor cardholder verification system of item 48 wherein target message signal comprising a cardholder option to accept confirmation (cardholder option accept confirmation) or decline confirmation (cardholder option decline confirmation) said cardholder data and PIN code received by ATM.
50) Item 50: The multi-factor cardholder verification system of item 48 and/or 49, wherein target message signal comprising a cardholder invalidate option (cardholder invalidate option) to issue a cardholder request to invalidate said cardholder data and PIN code received by ATM.
51) Item 51: The multi-factor cardholder verification system of item 48 to 51 wherein target message signal cardholder option accept confirmation, cardholder option decline confirmation, cardholder invalidate option each transcoded with a unique one-time return code.
52) Item 52: The multi-factor cardholder verification system of one of items 48 to 51 wherein cardholder inputs said unique one-time return code that corresponds to a desired cardholder option in target message signal received for transmittal to remote processor.
53) Item 53: The multi-factor cardholder verification system of one of items 48 to 52 wherein target message signal is a network-initiated USSD (unstructured supplementary service data) message type.
54) Item 54: A computer storage medium having instructions encoded thereon for facilitating multi-factor computer network user verification comprising storing at least one computer network user data on a primary database and storing computer network user verifying record on a secondary database wherein computer network user data on the primary database comprising at least a user ID (UID) is derived and utilized in at least one algorithmic function to yield and generate a record ID to be stored and operationally associated with computer network user verifying record on the said secondary database, comprising;
   said algorithmic function generating said record ID in one or more determined mathematical arrangement wherein computer network user verifying record stored on secondary database cannot be operationally associated with computer network user data on a primary database without algorithmic function, an machine-to-machine (MTM) authentication code, or a combination thereof; and
   computer network user verifying record comprising a digital signature, a digital certificate, a biometric profile data signal, a radio frequency (RF) profile data signal, a smart card profile data signal, a user password, a user passphrase, a user PIN code or combinations thereof.
55) Item 55: The computer storage medium of item 54 wherein machine-to-machine (MTM) authentication code is generated and transmitted to algorithmic function at each instance where computer network user attempts to gain logon access to an identified computer network in operational communication with primary database, secondary database, algorithmic function, or a combination thereof.
56) Item 56: A method for authentication of a user in an automated teller machine (ATM) system, comprising:
   reader device configured in the ATM for receiving from user a card apparatus to request and initiate a ATM transaction between the user and the ATM;
   a remote host computer configured to cause operational communication with the ATM and receiving a first data signal indicative of the data content of the card apparatus;
   said remote host computer receiving a second data signal and correlating the proximate geolocation coordinates of the user relative to the known proximate geolocation region of the ATM to derive a estimated error deviation value;
   remote host computer transmitting to ATM a third data signal in response to the first data signal, second data signal and estimated error deviation value for completing the said requested ATM transaction between said user and the ATM.
57) Item 57: The method of item 56 wherein first data signal further comprising data content indicative of a PIN code.
58) Item 58: The method of item 56 or 57, wherein remote host computer receives first data signal and retrieves from a remote database a known location identifier data operationally associated with the user.
59) Item 59: The method of one of items 56 to 58 wherein known location identifier data is selected from a cellular phone calling number, an instant messaging ID.
60) Item 60: The method of one of items 56 to 59 wherein remote host computer initiates and establishes a remote communications channel with the user using said known location identified data and retrieves from remote communications channel geolocation data indicative of the proximate location position of said user, comprising at least the estimated latitude, estimated longitude and accuracy of said estimated latitude, estimated longitude in meters to derive the proximate geolocation coordinates of the user.
61) Item 61: The method of one of items 56 to 60 wherein remote host computer transmits a formatted message string through the remote communications channel and monitors for a response signal indicative of at least a part of the second data signal returned from the user through said remote communications channel.

While the various embodiments above have been disclosed and described, it will be understood that there they are not to limit the application by such disclosure, and are intended to cover all modifications, alternative methods and steps within the spirit and scope of the application as defined in the claims. Where a specific advantage of an embodiment has been mentioned, it will be understood that a modified or alternative embodiment would also work without presenting such an advantage.

1) A transaction-processing system for performing verification of transactions between a plurality of users and a verification processor, said processor being provided in operational communication with a database which is storing a plurality of verification records, wherein each record comprising an unique ID and said record containing at least one unique user value, and each record comprising at least one reference device serial number value, and each verification record being associated with each of the said plurality of users, the system comprising:
a routine for reading a verification request message and routine associating said request message to an associated verification record stored on database,
the verification processor being provided for initiating a remote wireless communications link to a reference device associated with said verification record user value and sending a user input request message to said reference device,
the verification processor being provided for polling from said reference device a device serial number value,
the verification processor being provided for receiving from the reference device during remote wireless communications link a user response message in response to the said user input request message,
the transaction-processing system being provided for reading from the verification processor said retrieved device serial number value and performing a function call to match retrieved device serial number value against the reference device serial number value to generate a function call result value,
the transaction-processing system being provided for generating a verification response message using said function call result value and said received user response message, the said system further writing the generated verification response message to said first memory space,
the transaction-processing system being provided for performing and completing a verification of at least one transaction associated with the verification request message based in part on the generated verification response message.

2) The transaction-processing system for performing the verification of transactions between a plurality of users and a verification processor of claim 1, said processor in operational communication with a database storing a plurality of verification records, wherein each record comprising an unique ID and said record containing at least one MSISDN value, and each record comprising at least one reference device serial number value, and each verification record logically and uniquely associated with each of the said plurality of users, the system comprising:
(a) routine for reading from a first memory space a verification request message containing a push flag (PSH) and PSH is set and said system associating said request message to a verification record stored on database,
(b) verification processor initiating a remote wireless communications link to a phone device associated with said verification record MSISDN value and sending a user input request message to said phone device,
(c) verification processor sending a command routine during the said communications link to poll from said phone device a retrieved device serial number value,
(d) verification processor receiving from phone device during said communications link a user response message in response to the said user input request message, the verification processor generating a first input flag (INT1) if the received response message contains a first text identifier code, verification processor generating a second input flag (INT2) if said processor receives from said phone device said user response message containing a second text identifier code instead,
(e) the transaction-processing system reading from verification processor said retrieved device serial number value and performing a function call to match retrieved device serial number value against the reference device serial number value to generate either a match-pass flag (MTP) or a match-fail flag (MTF), wherein MTP is indicative of a match and MTF is indicative of a mismatch between said retrieved device serial number value and said reference device serial number value,
(f) verification processor generating a verification response message in the said first memory space using the generated flags from step (d) and step (e).

3) The transaction-processing system of claim 2, wherein reference device serial number value is a IMEI (international mobile equipment identity), or a MEID (Mobile Equipment Identifier), or a ESN (electronic serial number), or a IMSI (International Mobile Subscriber Identity).

4) The transaction-processing system of claim 2, wherein remote wireless communications link is a network initiated USSD (unstructured supplementary service data) messaging service.

5) The transaction-processing system of claim 2, wherein first memory space is in operative communication with at least one network domain selected from the group comprising of an ATM (automated teller machine) host network, a debit or credit card processing network, a POS (point-of-sale) terminal host network, an electronic banking application host network, a currency remittance application host network.

6) The transaction-processing system of claim 2, wherein said user input request message contains a plurality of unique transaction options each said option tagged with a unique text identifier code and a chosen transaction option is indicated in the said user response message by user input of the chosen said identifier code indicative of said chosen transaction option and transmittal of chosen text identifier code from said phone device to verification processor.

7) The transaction-processing system of claim 2, wherein said user input request message contains an input prompt for the user's PIN code, or user's CVV2, or the user's CVC2, or the user's card security code to be entered and transmitted from said phone device to verification processor.

8) The transaction-processing system for performing verification of transactions between a plurality of users and a verification processor of claim 1, wherein part of the said verification of each transaction is implemented between a gateway device and a phone device belonging to a specific user of each originating transaction of said plurality of users, the verification processor further comprising at least one gateway switch and a plurality of gateway devices are in operative communication with the gateway switch, verification processor in operative communication with a database and said processor receiving a plurality of transaction verification request signals, verification processor operable to read from each said verification request signal a primary account number belonging to a specific user, and retrieving using primary account number from said database a MSISDN value and a reference device serial number belonging to said specific user,
and verification processor routing the said MSISDN value to the gateway switch wherein the gateway switch will determine and a routine to generate and allocate each MSISDN request signal comprising said MSISDN value to a specific gateway device that is available and ready to execute each said transaction verification request signals, allocating routine comprising,
gateway switch interfacing with said plurality of gateways using network-initiated USSD messaging protocols for sending network-initiated messages addressed to a designated user MSISDN and for receiving said user MSISDN mobile originated messages addressed to said gateway device,
and allocating routine also comprising a routing configuration for routing said network-initiated messages from verification processor to the correct gateway device and for routing MSISDN mobile originating messages from gateway device to the correct verification processor specified said primary account number,
verification processor further comprising a fault routine for reading gateway device fault data and gateway device message traffic throttle rate to include into said routing configuration to select the least busy gateway device to perform and process transaction verification request signal, and verification processor including in said network-initiated message addressed to said designated user MSISDN at least one command routine operable to retrieve from user device bearing said MSISDN the said device serial number.

9) The transaction-processing system of claim 8, wherein the verification processor receives from gateway switch a specific user MSISDN mobile originated message containing the retrieved device serial number and performing a function call to match said serial number against the reference device serial number and said processor generating a first control signal if is there is a match or generating a second control signal if there is no match, said verification processor operable to generate a verification result signal based in part on said specific user MSISDN mobile originated message, said first or second control signal, or a combination thereof, verification result signal indicative of the outcome of verification of said user in association with said transaction operationally associated with said transaction verification request signal received.

10) The transaction-processing system of claim 1, providing a system for performing multi-factor ATM (automated teller machine) transaction verification between one or more user from a transaction originating network and a issuer-network, where said user attempts a ATM transaction with the transaction originating network using first verification part comprising a ATM card apparatus and input of a PIN code with a ATM unit in operational communication with the transaction originating network and a transaction request transmitted from transaction originating network to the issuer-network,
issuer-network comprising a routine code function for reading from transaction request determined data therein for retrieving from a database user's MSISDN and user's account information, and
interface function for interfacing with a plurality of external messaging gateways (EMG) using network-initiated USSD messaging protocols for sending one or more network-initiated message addressed to said user MSISDN and for receiving said user MSISDN mobile originated messages addressed to said EMG,
wherein said interfacing comprising a routing configuration for routing said network-initiated messages from issuer-network to the correct EMG and for routing MSISDN mobile originating messages from EMG to the correct issuer-network user account information,
and issuer-network comprising traffic routine code for reading EMG fault data and EMG message traffic throttle rate to include into said routing configuration to select the least busy EMG to perform user second verification part, the second verification part comprising:
(a) issuer-network providing in a network-initiated message addressed to user MSISDN a determined number of user input request options, and receiving from EMG user MSISDN mobile originated message indicative of an elected input option by said user and containing a retrieved user mobile device serial number, or
(b) issuer-network providing in a network-initiated message addressed to user MSISDN a keypad input request from said user for a PIN code, and receiving from EMG user MSISDN mobile originated message indicative of a PIN code provided by said user,
issuer-network using first and second verification parts against said user account information to derive and generate a transaction authorization,
issuer-network transmitting transaction authorization to the said transaction originating network.

11) The transaction-processing system for performing verification of transactions between a plurality of users and a verification processor of claim 10, for implementing cardholder verification using a verification processor to perform cardholder verification and said processor operable to provide a verification result data (VERD) numeric value for the transaction-processing system to generate an authorization response (ARQ) message for transmittal to a transaction originating network based in part on said VERD numeric value and cardholder account data (CAD) operationally associated with a determined cardholder, comprising:
said system receiving an authorization request (ARS) and reading from ARS the primary account number (PAN) of the cardholder for retrieval of a unique user value associated with said PAN from a database in operative communication with said processor, said processor operable to read from ARS the transaction amount and then generating a user input request message said message using a network-initiated USSD (unstructured supplementary service data) messaging service protocol containing the said transaction amount and a plurality of unique cardholder response options,
verification processor establishing a network-initiated USSD (unstructured supplementary service data) messaging service and sending said user input request message to a cardholder's elected communication device bearing said retrieved unique user value, the verification processor receiving during said USSD service a cardholder input elected response option data in response to user input request message, and verification processor generating a VERD numeric value corresponding to indicative intent of said cardholder input elected response option data,
verification processor providing said system with VERD numeric value, the transaction-processing system operable to generate first ARQ message to the transaction originating network based in part on said CAD indicative of an approved transaction code and said VERD numeric value is indicative of a successful verification implemented between verification processor and said cardholder elected communication device,
said system operable to generate second ARQ message to be indicative of a transaction declined or failed if said VERD numeric value is indicative of an unsuccessful verification implemented between verification processor and said cardholder elected communication device, and transmit the second ARQ message to the transaction originating network, regardless said CAD being indicative of an approved transaction code.

12) The transaction-processing system of claim 11, wherein a successful verification between the verification processor and said cardholder elected phone device is the result of the cardholder electing said response option data indicative of the cardholder's intention to confirm the transaction during said established USSD service.

13) The transaction-processing system of claim 11, wherein a successful verification between the verification processor and said cardholder elected phone device is the result of the cardholder electing said response option data indicative of the cardholder's intention to confirm the transaction during said established USSD service, and, said system finding a match between a device serial number obtained from cardholder elected phone device during said USSD service and a reference cardholder device serial number stored in said database.

14) The transaction-processing system of claim 11, wherein a successful verification between the verification processor and said cardholder elected phone device is the result of the cardholder electing said response option data inclusive of cardholder keypad input of a card security code, or CVV2 code, or CVC2 code indicative of the cardholder's intention to confirm the transaction during said established USSD service and said system finding a match between the said keypad input code and a reference cardholder keypad input code stored in verification processor, database, transaction processing system, or a combination thereof.

15) Method for performing verification of transactions between a plurality of users and a verification processor, said processor being provided in operational communication with a database which is storing a plurality of verification records, wherein each record comprising an unique ID and said record containing at least one unique user value, and each record comprising at least one reference device serial number value, and each verification record being associated with each of the said plurality of users, the method comprising:
reading a verification request message and routine associating said request message to an associated verification record stored on database,
initiating a remote wireless communications link to a reference device associated with said verification record user value and sending a user input request message to said reference device,
polling from said reference device a device serial number value,
receiving from the reference device during remote wireless communications link a user response message in response to the said user input request message,
reading from the verification processor said retrieved device serial number value and performing a function call to match retrieved device serial number value against the reference device serial number value to generate a function call result value,
generating a verification response message using said function call result value and said received user response message, and writing the generated verification response message to said first memory space,
performing and completing a verification of at least one transaction associated with the verification request message based in part on the generated verification response message.

16) A computer storage medium having instructions encoded thereon for determining whether a mobile telephone number provided in association with a financial transaction is a valid transaction token or a non-valid transaction token, and for evaluating, based at least in part on the determination, the validity of the financial transaction, the computer storage medium comprising:
a computer encoded instruction for receiving input indicative of a mobile telephone number for an entity participating in a financial transaction;
a computer encoded instruction for initiating and delivering a network-initiated, USSD service or other instant messaging service intended and addressed to the mobile telephone number;
a computer encoded instruction for obtaining a device serial number during said USED service or other instant messaging service;
a computer encoded instruction for determining whether the obtained device serial number indicates that the mobile telephone number is a valid transaction token or a non-valid transaction token;
a computer encoded instruction for evaluating the validity of the financial transaction, based at least in part on the determination;
a computer encoded instruction for storing a retrievable record comprising at least one of: the mobile telephone number, the reference device serial number; and
a computer encoded instruction for accessing the retrievable record in association with a subsequent financial transaction in order to use information in the record to evaluate the validity of the subsequent financial transaction token.

17) The computer storage medium of claim 16, wherein the computer encoded instruction for evaluating transaction token validity comprises a computer-encoded instruction for comparing and matching the obtained device serial number against the reference device serial number, and said transaction token evaluated as valid if there is a match or transaction token evaluated as non-valid if there is no match.

18) The computer storage medium according to claim 16, having instructions encoded thereon for determining whether a mobile telephone number provided in association with a user transaction is a valid transaction token or a non-valid transaction token, and for evaluating, based at least in part on the determination, the validity of the user transaction, the computer storage medium comprising:
a computer encoded instruction for receiving input indicative of a mobile telephone number for an entity participating in a user transaction; a computer encoded instruction for storing a retrievable record comprising at least one of: the mobile telephone number, the reference device serial number;
a computer encoded instruction for initiating and delivering a network-initiated, USSD service or other instant messaging service intended and addressed to the mobile telephone number; a computer encoded instruction for obtaining a device serial number during said USSD service or other instant messaging service;
a computer encoded instruction for determining whether the obtained device serial number indicates that the mobile telephone number is a valid transaction token or a nom valid transaction token, said computer encoded instruction for evaluating transaction token validity comprises a computer-encoded instruction for comparing and matching the obtained device serial number against the reference device serial number, and said transaction token evaluated as valid if there is a match or transaction token evaluated as non-valid if there is no match;
a computer encoded instruction for sending a one-time generated code for use with the user transaction wherein said one-time generated code is delivered using the said USSD service or other instant messaging service;
a computer encoded instruction for evaluating the validity of the user transaction, based at least in part on the determination and the one-time generated code delivered; and
a computer encoded instruction for accessing the retrievable record in association with a subsequent user transaction in order to use information in the record to evaluate the validity of the subsequent user transaction token.

19) The computer storage medium according to claim 16, having instructions encoded thereon for facilitating debit-credit card multi-factor user verification comprising storing at least one debit-credit card user data on a primary database and storing debit-credit card user verifying record on a secondary database wherein debit-credit card user data on the primary database comprising at least a primary account number (PAN) is derived and utilized in at least one algorithmic function to yield and generate a record ID to be stored and operationally associated with debit-credit card user verifying record on the said secondary database, comprising;
said algorithmic function generating said record ID in one or more determined mathematical arrangement wherein debit-credit card user verifying record stored on secondary database cannot be operationally associated with debit-credit card user data on a primary database without algorithmic function, an machine-to-machine (MTM) authentication code, or a combination thereof; and
debit-credit card user verifying record comprising a digital signature, a digital certificate, a biometric profile data signal, a radio frequency (RF) profile data signal, a smart card profile data signal, a user ID, a user password, a user passphrase, or combinations thereof.

20) The computer storage medium of claim 19, wherein machine-to-machine (MTM) authentication code is generated and transmitted to algorithmic function at each instance where a debit-credit card transaction request message is received.
